(19) United States
(12) Patent Application Publication
(10) Pub. No.: US 2016/0247034 A1
(43) Pub. Date: Aug. 25, 2016

(54) METHOD AND APPARATUS FOR MEASURING THE QUALITY OF AN IMAGE

(71) Applicant: SAMSUNG ELECTRONICS CO., LTD., Suwon-si (KR)

(72) Inventors: Heekuk LEE, Suwon-si (KR); Dae-Kyu SHIN, Suwon-si (KR); Yumin JUNG, Suwon-si (KR)

(21) Appl. No.: 15/049,428

(22) Filed: Feb. 22, 2016

(30) Foreign Application Priority Data
Feb. 24, 2015 (KR) 10-2015-0025854

(51) Int. Cl. G06K 9/03; G06K 9/46; G06K 9/66; G06K 9/62

(52) U.S. Cl. CPC G06K 9/036; G06K 9/6267; G06K 9/46; G06K 9/66

(57) ABSTRACT

An electronic device that includes an image quality measuring function and an operation method thereof are disclosed. An image quality measuring method includes: obtaining an image; classifying an image scene category of the image; determining a classifier corresponding to the classified image scene category; determining image quality factor scores with respect to the image; and evaluating image quality with respect to the image by using the determined image quality factor scores and the determined classifier.

### CROSS-REFERENCE TO RELATED APPLICATION

This application is based on and claims priority under 35 U.S.C. §119 to Korean Application Serial No. 10-2015-0025854, which was filed in the Korean Intellectual Property Office on Feb. 24, 2015, the disclosure of which is incorporated by reference herein in its entirety.

### TECHNICAL FIELD

The present disclosure relates to an electronic device that improves detectability in association with a measurement of the quality of an image, and a method of operating the same.

### BACKGROUND

As digital technologies have developed, various types of electronic devices are widely utilized, such as a terminal, a smart phone, a tablet Personal Computer (PC), a Personal Digital Assistant (PDA), an electronic organizer, a notebook, a wearable device, or the like. The electronic devices have reached a level of mobile convergence that includes the functions of other devices. For example, the electronic devices may provide: a communication function, such as a voice call, a video call, and the like; a message transmission/reception function, such as a Short Message Service (SMS)/Multimedia Message Service (MMS), an e-mail, and the like; an electronic organizer function; a photographing function; a broadcasting program playback function; a video playback function; a music playback function; an Internet function; a messenger function; a game function; a Social Networking Service (SNS) function; or the like.

An electronic device provides a function of measuring the quality of an image. A conventional image quality measurement scheme evaluates the quality by measuring an image quality factor, such as sharpness, noise, contrast, color accuracy, distortion, blur, and the like, or evaluates the total image quality by normalizing scores of image quality factors to be different or by applying different weights to image quality factors.

### SUMMARY

When an existing electronic device measures a blur from among image quality factors, various blur detection algorithms may be used. For example, a value (e.g., blur-per value) indicating a degree of a sharp area in an image and a value (e.g., blur-extent value) indicating a degree of a blur area may be used. However, the simple arithmetic combination, such as the blur measurement scheme, may have a low detectability in association with a motion blur. To improve the detectability in association with the motion blur, a detection method that uses kernel estimation may be used. However, this proceeds slowly, and may be difficult to be implemented in an electronic device. Also, the conventional image quality measurement may have a low distinction in association with an out-of-focus background image (e.g., a blurred background image), which is a drawback.

Also, according to the existing method used for an electronic device to evaluate the total image quality using an image quality factor, the total image quality may be calculated by applying a different weight to each image quality factor, or using a classifier (e.g., a Support Vector Machine (SVM) classifier or a naive bayes classifier) through learning. According to the method, the total image quality is evaluated to be good but the performance of the single classifier may become deteriorated.

According to various example embodiments of the present disclosure, a method and apparatus for supporting the improvement of the detectability in association with an image quality measurement are provided.

According to various example embodiments of the present disclosure, an image quality measuring method and apparatus are provided that may improve the detectability in association with an out-of-focus background image, the detectability in association with a motion blur, and the performance in association with a total image quality evaluation when the quality of an image is measured.

According to various example embodiments of the present disclosure, an electronic device is provided, including: a memory that stores a plurality of images and a plurality of classifiers; and a processor that is electrically connected with the memory, wherein the processor is configured to: analyze a category of an image of which an image quality evaluation is requested, and determine a classifier corresponding to the category of the image from among the plurality of classifiers; determine image quality factor scores of the image; and evaluate the image quality of the image based on the determined image quality factor scores and the determined classifier.

According to various example embodiments of the present disclosure, a system that supports measuring the quality of an image is provided, the system including: a first electronic device configured to request an image quality evaluation of an image; and a second electronic device that is connected to the first electronic device, wherein the second electronic device is configured to: obtain the image from the first electronic device; analyze a category of the image, and determine a classifier corresponding to the category of the image; determine image quality factor scores of the image; and evaluate image quality of the image based on the determined image quality factor scores and the determined classifier, and provide the first electronic device with a result of the image quality evaluation.

According to various example embodiments of the present disclosure, a method of measuring the quality of an image is provided, the method including: obtaining an image; classifying an image scene category of the image; determining a classifier corresponding to the classified image scene category; determining image quality factor scores with respect to the image; and evaluating image quality with respect to the image using the determined image quality factor scores and the determined classifier.

To overcome the above described drawbacks of the prior art, various example embodiments of the present disclosure may include a computer readable recording medium in which programs for implementing the method in a processor are recorded.

According to various example embodiments of the present disclosure, there is provided a computer readable recording medium that stores a program, which when executed, causes an electronic device to be configured to: classify an image scene category of an image and determine a classifier corresponding to the classified image scene category; determine image quality factor scores with respect to the image; and evaluate image quality with respect to the image using the determined image quality factor scores and the determined classifier.

### BRIEF DESCRIPTION OF THE DRAWINGS

The above and other aspects, features, and advantages of the present disclosure will be more apparent from the following detailed description, taken in conjunction with the accompanying drawings, in which like reference numerals refer to like elements, and wherein:

FIG. 1 is a diagram illustrating an example network environment including an electronic device;

FIG. 2 is a block diagram illustrating an example electronic device;

FIG. 3 is a block diagram illustrating an example program module;

FIG. 4 is a block diagram schematically illustrating an example configuration of an electronic device;

FIG. 5 is a diagram illustrating an example configuration for measuring the quality of an image in an electronic device;

FIG. 6 is a flowchart illustrating an example method of measuring the quality of an image in an electronic device;

FIG. 7 is a flowchart illustrating an example of measuring an image quality factor of a special image in an electronic device;

FIGS. 8A to 8C are diagrams illustrating examples of an operation of extracting a quality factor of an out-of-focus image in an electronic device;

FIG. 9 is a flowchart illustrating an example of an operation of measuring an image quality factor of a special image in an electronic device;

FIGS. 10A to 10C are diagrams illustrating examples of an operation of extracting a quality factor of a motion blur image in an electronic device;

FIG. 11 is a flowchart illustrating an example of an operation of determining an image quality classifier in an electronic device;

FIGS. 12A and 12B are diagrams illustrating examples of an image quality classifier in an electronic device;

FIG. 13 is a flowchart illustrating an example method of measuring the quality of an image in an electronic device; and

FIG. 14 is a sequence diagram illustrating an example of a method of measuring the quality of an image.

### DETAILED DESCRIPTION

Hereinafter, various example embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various example embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. On the other hand, it may be understood that when an element (e.g., first element) is referred to as being “directly connected,” or “directly coupled” to another element (second element), there is no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. In some situations, the expression “device configured to” may refer to the device, together with other devices or components, “is able to”. For example, the phrase “processor adapted (or configured) to perform A, B, and C” may refer to a dedicated processor (e.g. embedded processor) only for performing the corresponding operations or a general-purpose processor (e.g., central processing unit (CPU) or application processor (AP)) or processing circuitry that can perform the corresponding operations by executing one or more software programs stored in a memory device.

The terms used in the present disclosure are used to describe various example embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. Even where a term is defined in the present disclosure, it should not be interpreted to exclude embodiments of the present disclosure.

An electronic device according to various example embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device, or the like. According to various example embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like.

According to some example embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like.

According to another example embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like.

According to some example embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like. The electronic device according to various example embodiments of the present disclosure may be a combination of one or more of the aforementioned various devices. The electronic device according to some example embodiments of the present disclosure may be a flexible device. Further, the electronic device according to an example embodiment of the present disclosure is not limited to the aforementioned devices, and may include a new electronic device according to the development of technology.

Hereinafter, an electronic device according to various example embodiments will be described with reference to the accompanying drawings. As used herein, the term “user” may indicate a person who uses an electronic device or a device (e.g., an artificial intelligence electronic device) that uses an electronic device.

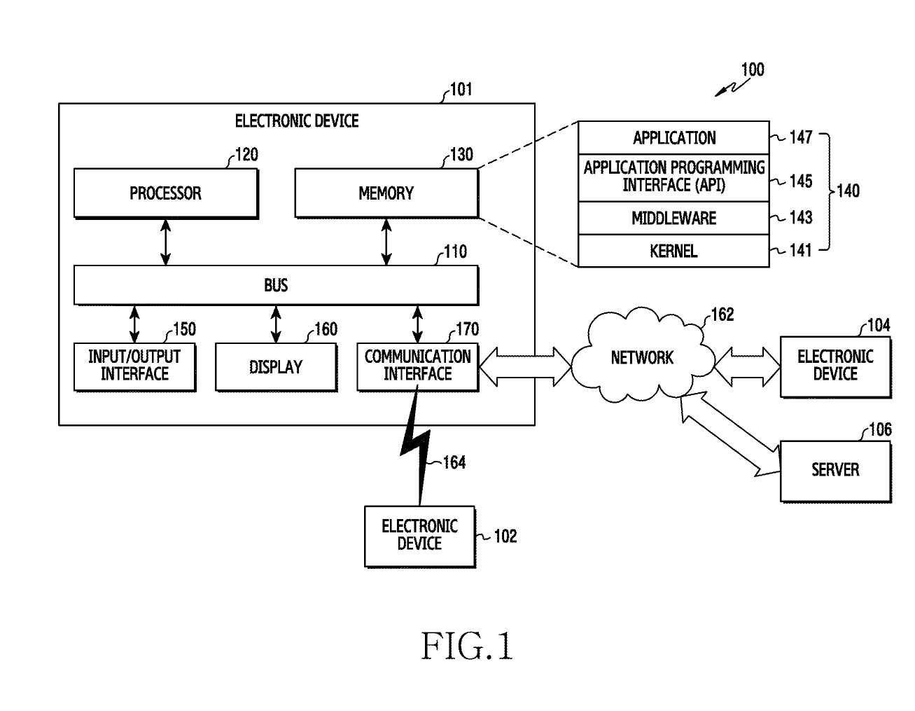

FIG. 1 is a diagram illustrating an example network environment including an electronic device.

An electronic device 101 within a network environment 100, according to various example embodiments, will be described with reference to FIG. 1. The electronic device 101 may include a bus 110, a processor (e.g., including processing circuitry) 120, a memory 130, an input/output interface (e.g., including input/output circuitry) 150, a display (e.g., including a display panel and display circuitry) 160, and a communication interface (e.g., including communication circuitry) 170. According to an example embodiment of the present disclosure, the electronic device 101 may omit at least one of the above components or may further include other components.

The bus 110 may include, for example, a circuit which interconnects the components 110 to 170 and delivers a communication signal (e.g., a control message and/or data) between the components 110 to 170.

The processor 120 may include, for example, processing circuitry including, for example, one or more of a Central Processing Unit (CPU), an Application Processor (AP), and a Communication Processor (CP). The processor 120 may be configured to carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an example embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display, or the like. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part, or the like.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106). The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), or the like, as a cellular communication protocol. In addition, the wireless communication may include, for example, short range communication 164. The short-range communication 164 may include at least one of, for example, Wi-Fi, Bluetooth, Near Field Communication (NFC), and Global Navigation Satellite System (GNSS), or the like. GNSS may include, for example, at least one of global positioning system (GPS), global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS), or the like. The network 162 may include at least one of a telecommunication network such as a computer network (e.g., a LAN or a WAN), the Internet, and a telephone network, or the like.

Each of the first and second external electronic devices 102 and 104 may be of a type similar to or different from that of the electronic device 101. According to an example embodiment of the present disclosure, the server 106 may include a group of one or more servers. According to various example embodiments of the present disclosure, all or some of the operations performed in the electronic device 101 may be executed in another electronic device or a plurality of electronic devices (e.g., the electronic devices 102 and 104 or the server 106). According to an example embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies, or the like, may be used.

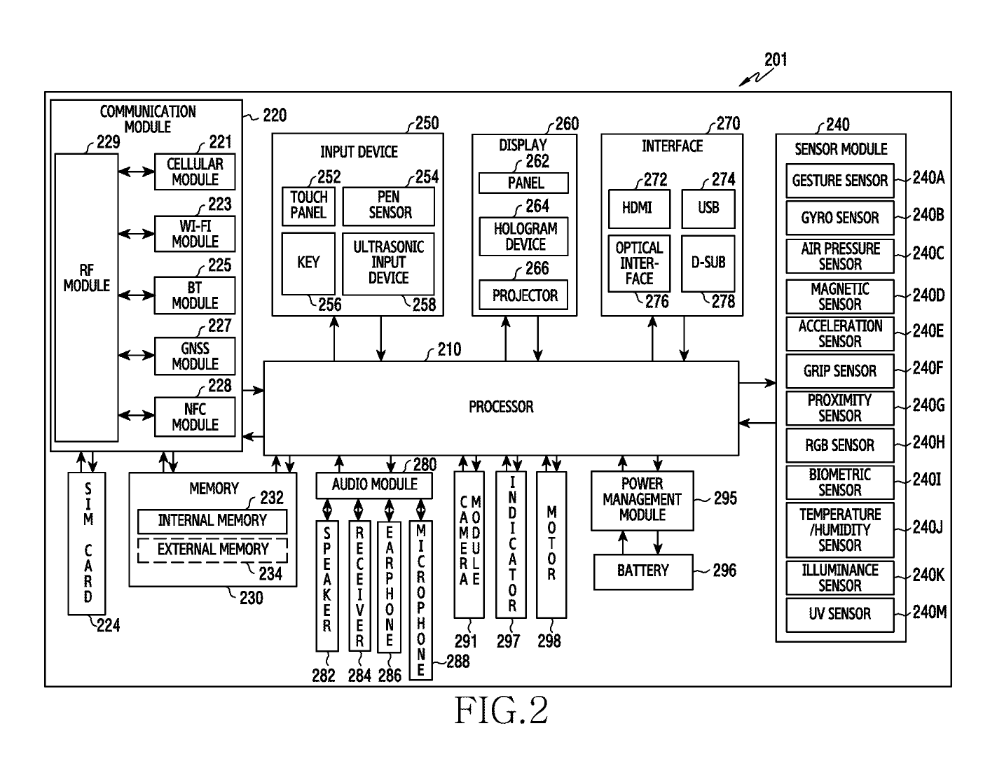

FIG. 2 is a block diagram illustrating an example electronic device.

The electronic device 201 may include, for example, all or a part of the electronic device 101 shown in FIG. 1. The electronic device 201 may include one or more processors (e.g., including processing circuitry) 210 (e.g., Application Processors (AP)), a communication module (e.g., including communication circuitry) 220, a Subscriber Identification Module (SIM) 224, a memory 230, a sensor module (e.g., including at least one sensor including sensor circuitry) 240, an input device (e.g., including input circuitry) 250, a display 260, an interface (e.g., including interface circuitry) 270, an audio module (e.g., including audio processing circuitry) 280, a camera module 291, a power management module 295, a battery 296, an indicator 297, and a motor 298.

The processor 210 may be configured to control a plurality of hardware or software components connected to the processor 210 by driving an operating system or an application program, and perform processing of various pieces of data and calculations. The processor 210 may, for example, be embodied as, for example, processing circuitry included on a System on Chip (SoC). According to an example embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a BT module 225, a GNSS module 227 (e.g., a GPS module 227, a Glonass module, a Beidou module, or a Galileo module), an NFC module 228, and a Radio Frequency (RF) module 229.

The cellular module 221, for example, may provide a voice call, a video call, a text message service, or an Internet service through a communication network. According to an example embodiment of the present disclosure, the cellular module 221 may distinguish and authenticate the electronic device 201 in a communication network using the subscriber identification module 224 (for example, the SIM card). According to an example embodiment of the present disclosure, the cellular module 221 may perform at least some of the functions that the AP 210 may provide. According to an example embodiment of the present disclosure, the cellular module 221 may include a communication processor (CP).

For example, each of the Wi-Fi module 223, the BT module 225, the GNSS module 227, and the NFC module 228 may include a processor for processing data transmitted/received through a corresponding module. According to an example embodiment of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229, for example, may transmit/receive a communication signal (e.g., an RF signal). The RF module 229 may include, for example, a transceiver, a Power Amplifier Module (PAM), a frequency filter, a Low Noise Amplifier (LNA), and an antenna. According to another example embodiment of the present disclosure, at least one of the cellular module 221, the WIFI module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an embedded memory 232 or an external memory 234. The embedded memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like), or the like.

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 2401, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor, or the like. The sensor module 240 may further include a control circuit for controlling one or more sensors included therein. According to an example embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air using an interference of light. The projector 266 may project light onto a screen to display an image. The screen may be located, for example, in the interior of or on the exterior of the electronic device 201. According to an example embodiment of the present disclosure, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface, or the like.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an example embodiment of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an example embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or mediaFLO™.

Each of the above-described component elements of hardware according to the present disclosure may be configured with one or more components, and the names of the corresponding component elements may vary based on the type of electronic device. In various example embodiments, the electronic device may include at least one of the above-described elements. Some of the above-described elements may be omitted from the electronic device, or the electronic device may further include additional elements. Also, some of the hardware components according to various example embodiments may be combined into one entity, which may perform functions identical to those of the relevant components before the combination.

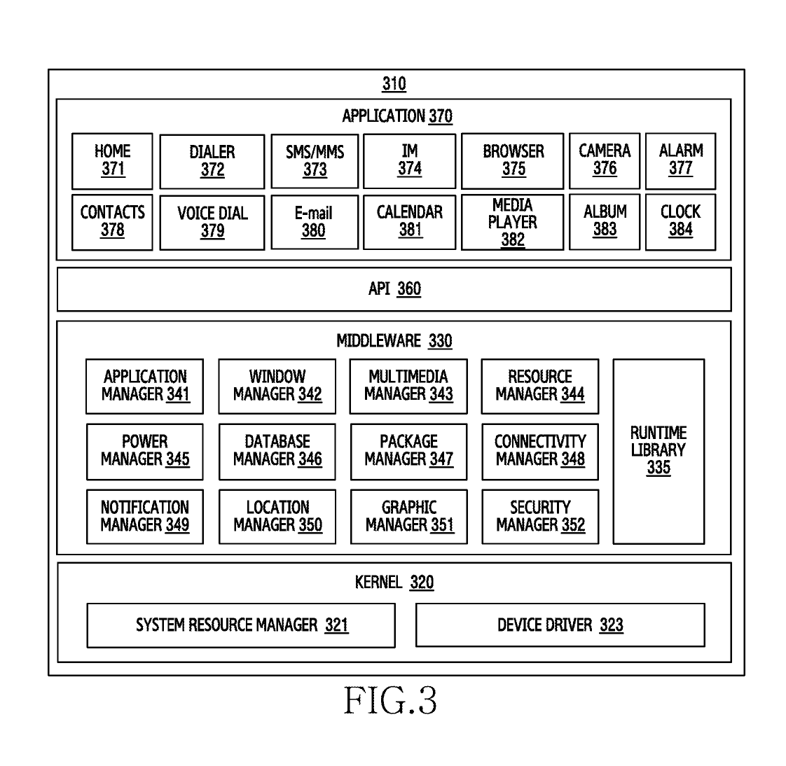

FIG. 3 is a block diagram illustrating an example program module.

According to an example embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, Android, iOS, Windows, Symbian, Tizen, Bada, or the like.

The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an example embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 to enable the applications 370 to efficiently use the limited system resources in the electronic device. According to an example embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a Basic Input/Output System (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an example embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which may provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, a clock 384, health care (e.g., measuring exercise quantity or blood sugar), or environment information (e.g., providing atmospheric pressure, humidity, or temperature information).

According to an example embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an example embodiment of the present disclosure, the applications 370 may include applications (e.g., a health care application of a mobile medical appliance or the like) designated according to an external electronic device (e.g., attributes of the electronic device 102 or 104). According to an example embodiment of the present disclosure, the applications 370 may include an application received from an external electronic device (e.g., the server 106, or the electronic device 102 or 104). According to an example embodiment of the present disclosure, the applications 370 may include a preloaded application or a third party application that may be downloaded from a server. The names of the components of the program module 310 of the illustrated embodiment of the present disclosure may change according to the type of operating system.

According to various example embodiments, at least a part of the programming module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware (e.g., circuitry), software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of processing circuitry, an Application-Specific Integrated Circuit (ASIC) chip, a Field-Programmable Gate Arrays (FPGA), and a programmable-logic device for performing operations which has been known or are to be developed hereinafter.

According to various example embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high level language codes, which can be executed in a computer using an interpreter, as well as machine codes made by a compiler. The aforementioned hardware device may be configured to operate as one or more software modules in order to perform the operation of the present disclosure, and vice versa.

Any of the modules or programming modules according to various example embodiments of the present disclosure may include at least one of the above described elements, exclude some of the elements, or further include other additional elements. The operations performed by the modules, programming module, or other elements according to various example embodiments of the present disclosure may be executed in a sequential, parallel, repetitive, or heuristic manner. Further, some operations may be executed according to another order or may be omitted, or other operations may be added. Various example embodiments disclosed herein are provided merely to easily describe technical details of the present disclosure and to aid in the understanding of the present disclosure, and are not intended to limit the scope of the present disclosure. Therefore, it should be construed that all modifications and changes or modified and changed forms based on the technical idea of the present disclosure fall within the scope of the present disclosure.

Various example embodiments of the present disclosure provided below are related to an electronic device that includes an image quality measuring function, and a method of operating the same. According to various example embodiments of the present disclosure, detectability may be improved in association with an image (e.g., an out-of-focus background image, a motion blur image, or the like) to which special effects (e.g., out-of-focus, a motion blur, or the like) are applied when an image is generated (photographed), when an electronic device determines an image quality score in association with the measurement of the quality of an image. According to various example embodiments of the present disclosure, an electronic device may improve the performance (e.g., accuracy) in association with a total image quality evaluation through improving the detectability with respect to an out-of-focus background image or a motion-blur image.

According to various example embodiments of the present disclosure, an electronic device may measure an image quality by distinguishing each property of an image (e.g., an out-of-focus background image, a motion blur image, or the like). According to various example embodiments of the present disclosure, an electronic device may classify an image based on an image scene category (e.g., mountain, ocean, sky, beach, streets, night view, or the like) when measuring the quality of the image, and may determine an image scene classifier corresponding to the corresponding image scene category. According to various example embodiments of the present disclosure, the image quality may be determined by applying, to the image, a different weight based on the determined image scene classifier.

According to various example embodiments of the present disclosure, when an electronic device is configured to perform total image quality evaluation, the image quality may be determined based on the property of an image and an image scene category. Therefore, according to various example embodiments of the present disclosure, the detectability, with respect to an image in association with the total image quality evaluation, and the accuracy of a quality determination result may be improved.

According to various example embodiments of the present disclosure, an electronic device operates in various electronic devices that contain an image quality measuring function. For example, an electronic device, according to various example embodiments of the present disclosure, may include all devices that use one or more processors from among various processors (e.g., the processors 120 and 210), such as, an application processor (AP), a communication processor (CP), a graphic processing unit (GPU), a central processing unit (CPU), and the like, for example, all information communication devices that support a function according to various example embodiments (e.g., an image quality measuring function), multimedia devices, wearable devices, and application devices thereof.

Hereinafter, a method and apparatus for performing an image quality measuring function, using an electronic device according to various example embodiments of the present disclosure, will be described. However, various example embodiments of the present disclosure may not be limited to the descriptions provided below and thus, it should be understood that the present disclosure may be applied to various example embodiments based on the example embodiments provided below. Also, various example embodiments of the present disclosure will be provided from the perspective of hardware. However, various example embodiments of the present disclosure include a technology that uses both hardware and software, and thus, the various example embodiments of the present disclosure may not exclude the perspective of software.

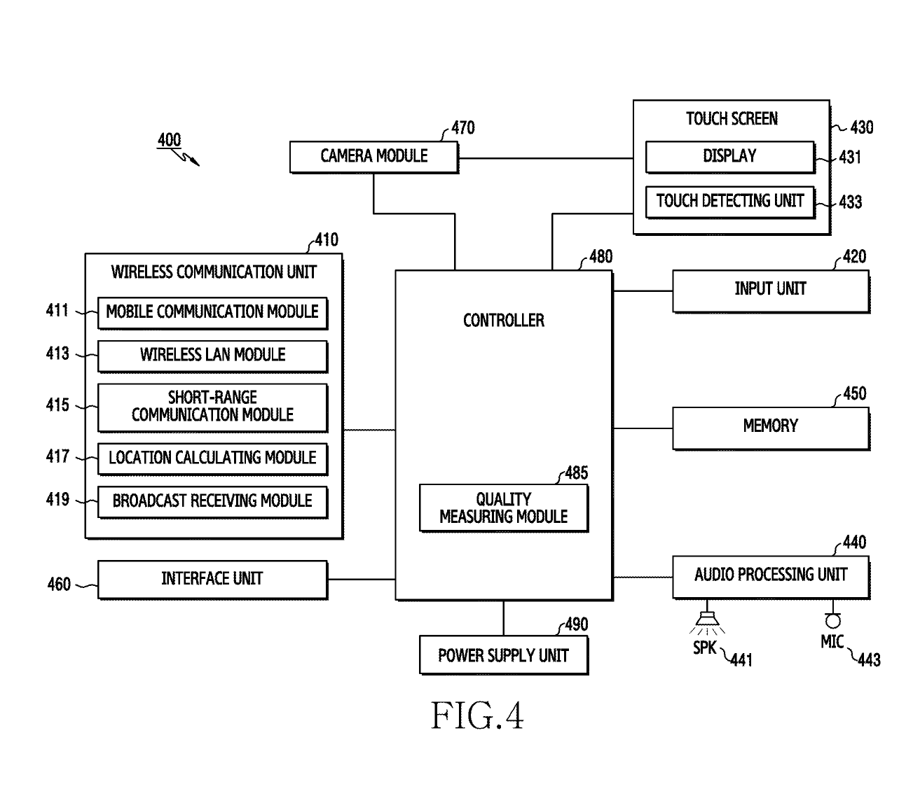

FIG. 4 is a block diagram schematically illustrating an example configuration of an electronic device.

Referring to FIG. 4, an electronic device 400, according to various example embodiments of the present disclosure, may include a wireless communication unit (e.g., including wireless communication circuitry) 410, an input unit (e.g., including input circuitry) 420, a touch screen 430, an audio processing unit (e.g., including audio processing circuitry) 440, a memory 450, an interface unit (e.g., including interface circuitry) 460, a camera module 470, a controller (e.g., including processing circuitry) 480, and a power supply unit 490. According to various example embodiments of the present disclosure, the electronic device 400 may include fewer or more component elements when compared to the component elements of FIG. 4, since the component elements of FIG. 4 are not essential.

The wireless communication unit 410 may include a configuration that is identical or similar to the communication module 220 of FIG. 2. The wireless communication unit 410 may include one or more modules that enable wireless communication between the electronic device 400 and a wireless communication system or between the electronic device 400 and another electronic device (e.g., the electronic device 102 or 104, or the server 160). For example, the wireless communication unit 410 may be configured to include a mobile communication module 411, a wireless local area network (WLAN) module 413, a short-range communication module 415, a location calculating module 417, a broadcast receiving module 419, and the like. According to various example embodiments of the present disclosure, the wireless communication unit 410 may execute wireless communication with an external electronic device (e.g., the electronic device 102 or 104, or the server 106) based on at least some of various set communication schemes, and may receive various images based on wireless communication.

The mobile communication module 411 may transmit/receive a wireless signal to/from at least one of a base station, an external electronic device (e.g., the electronic device 104), and various servers (e.g., an integration server, a provider server, a content server, an Internet server, a cloud server, or the like) on a mobile communication network. The wireless signal may include a voice call signal, a video call signal, and data in various forms according to the transmission and reception of text/multimedia messages.

The mobile communication module 411 may receive one or more data (e.g., contents, a message, a mail, an image, a video, weather information, location information, time information, and the like). According to an example embodiment of the present disclosure, the mobile communication module 411 may obtain (receive) various pieces of data by being connected with at least one of other devices (e.g., the electronic device 104 or the server 106), which are connected with the electronic device 400 over a network (e.g., the mobile communication network). The mobile communication module 411 may transmit various pieces of data required for the operations of the electronic device 400, to an external device (e.g., the server 104, another electronic device 104, or the like), in response to a user's request.

The mobile communication module 411 may execute a communication function. For example, the mobile communication module 411 may convert a radio frequency (RF) signal into a baseband signal and transmit the same to the controller 480 under the control of the controller 480, or may convert the base band signal from the controller 480 into an RF signal and transmit the same. For example, the controller 480 may be configured to process a baseband signal based on various communication schemes. For example, the communication scheme may include an Long-Term Evolution (LTE) communication scheme, an LTE advance (LTE-A) communication scheme, Global System for Mobile Communication (GSM) communication scheme, Enhanced Data GSM Environment (EDGE) communication scheme, Code Division Multiple Access (CDMA) communication scheme, W-Code Division Multiple Access (W-CDMA) communication scheme, or Orthogonal Frequency Division Multiple Access (OFDMA) communication scheme, or the like, but the communication scheme may not be limited thereto.

The wireless LAN module 413 may include a module for establishing a wireless Internet access and a wireless LAN link with another electronic device (e.g., the electronic device 102 or the server 106). The wireless LAN module 413 may be embedded in the electronic device 400 or may separately exist outside the electronic device 400. Wireless Internet technology may include wireless fidelity (WiFi), wireless broadband (Wibro), world interoperability for microwave access (WiMax), high speed downlink packet access (HSDPA), millimeter wave (mmWave), or the like.

The wireless LAN module 413 may transmit or receive one or more pieces of data selected by a user to/from the outside. According to an example embodiment of the present disclosure, the wireless LAN module 413 works together with at least one of external devices (e.g., another electronic device or a server), which are connected with the electronic device 400 over a network (e.g., a wireless Internet network), and transmits or receives various data of the electronic device 400 to/from the external device. The wireless LAN module 413 may always maintain the ON-state, or may be turned on based on settings of the electronic device 400 or a user input.

The short-range communication module 415 may be a module for performing short-range communication. The short-range communication technology may include Bluetooth, Bluetooth low energy (BLE), a radio frequency identification (RFID), infrared data association (IrDA), ultra wideband (UWB), Zigbee, Near Field Communication (NFC), and the like.

The short-range communication module 415 may receive one or more pieces of data. According to an example embodiment of the present disclosure, the short-range communication module 415 works together with an external device (e.g., another electronic device) that is connected with the electronic device 400 over a network (e.g., a short-range communication network), and transmits or receives various data of the electronic device 400 to/from the external device. The short-range communication module 415 may always maintain the ON-state, or may be turned on based on settings of the electronic device 400 or a user input.

The location calculating module 417 may be a module for obtaining the location of the electronic device 400, and may include a global position system (GPS) module as a representative example. The location calculating module 415 may measure the location of the electronic device 4100 based on the principals of triangulation. The location calculation module 417 may calculate three dimensional information on a current location according to a latitude, a longitude, and an altitude, by calculating distance information associated with a distance away from three or more base stations and time information, and then applying triangulation to the calculated information. Furthermore, the location calculating module 417 may calculate location information by continuously receiving location information of the electronic device 400 from three or more satellites in real time. The location information of the electronic device 400 may be obtained by various methods.

The broadcast receiving module 419 may receive a broadcast signal (e.g., a TV broadcast signal, a radio broadcast signal, a data broadcast signal, and the like) and/or broadcast related information (e.g., information associated with a broadcast channel, a broadcast program, or a broadcast service provider) from an external broadcast management server through a broadcast channel (e.g., a satellite broadcast channel, a terrestrial broadcast channel, or the like).

The input unit 420 may generate input data for controlling the operations of the electronic device 400, in response to, for example, a user input. The input unit 420 may include at least one input device for detecting various inputs of the user. For example, the input unit 420 may include a key pad, a dome switch, a physical button, a touch pad (resistive/capacitive type), jog & shuttle, a sensor (e.g., the sensor module 240), or the like.

A part of the input unit 420 may be embodied outside the electronic device 400 in the form of a button, or a part or the whole of the user input unit 420 may be embodied as a touch panel. The input unit 420 may receive a user input for initiating the operations of the electronic device 400 according to various example embodiments of the present disclosure, or may generate an input signal based on a user input. For example, the input unit 420 may receive various user inputs for measuring an image quality, photographing an image, executing an application, inputting (writing or inserting) data, changing the position of the electronic device 400, displaying contents, transmitting or receiving data, or the like, and may generate an input signal based on the user input.

The touch screen 430 may include an input/output means that simultaneously executes an input function and a display function, and may include a display 431 (e.g., the display 160 or 260), and a touch sensing unit 433. The touch screen 430 may provide an input/output interface between the electronic device 400 and the user, may transfer a touch input of the user to the electronic device 400, and may serve as a medium that shows an output from the electronic device 400 to the user. The touch screen 430 may show a visual output to the user. The visual output may be shown in the form of a combination of text, graphics, and videos. For example, according to example embodiments of the present disclosure, the touch screen 430 may display various screens associated with operations of the electronic device 400, through the display 431. The various screens may include various User Interface (UI)-based screens that may be displayed to correspond to an executed application, for example, an image screen, an image quality measurement result screen, a messenger screen, a call screen, a game screen, a video reproduction screen, a gallery screen, a webpage screen, a home screen, a network connection screen, or the like.

The touch screen 430 may detect an event based on at least one of a touch, a hovering, and an air gesture (e.g., a touch event, a hovering event, an air gesture event), which are provided from a user, through the touch detecting unit 433, while displaying a predetermined screen through the display 431, and may transfer an input signal associated with the event to the controller 480. The controller 480 may distinguish a transferred event, and may control executing an operation based on the distinguished event.

According to various example embodiments of the present disclosure, the display 431 may display (output) various information processed in the electronic device 400. For example, the display 431 may display a User Interface (UI) or a graphic UI (GUI) associated with image quality measurement when the electronic device 400 measures the quality of an image. The display 431 may display a UI or a GUI associated with calling when the electronic device 400 operates in a call mode. Also, the display 431 may display a photographed or/and received image and a UI or GUI associated with operating a corresponding mode, when the electronic device 400 is in a video call mode or a photographing mode. The display 431 may display data associated with the use of the electronic device 400, contents, or information associated with an external device that is connected with a network. The display 431 may display various application execution screens corresponding to an executed application.

The display 431 may support displaying a screen based on a landscape mode, displaying a screen based on a portrait mode, or displaying a screen based on a change between the landscape mode and the portrait mode, according to a rotation direction (or an orientation) of the electronic device 400. The display 431 may use various displays (e.g., the display 160). A few displays may be embodied as a transparent display formed in a transparent type or an optical transparent type.

The touch detecting unit 433 may be mounted on the display 431, and may detect a user input that is in contact with, or in proximity to, the surface of the touch screen 430. The user input may include a touch event or a proximity event that is input based on at least one of a single-touch, a multi-touch, a hovering, and an air gesture. For example, the user input may be input by a tap, a drag, a sweep, a flick, a drag & drop, or a drawing gesture (e.g., writing) or the like. The touch detecting unit 433 may detect a user input (e.g., a touch event or a proximity event) on the surface of the touch screen 430, generate a signal corresponding to the detected user input, and transfer the same to the controller 480. The controller 480 may control the execution of a function corresponding to an area where the user input (e.g., a touch event or a proximity event) is generated by the signal transferred from the touch detecting unit 433.

The touch detecting unit 433 may receive a user input for initiating the operations of the electronic device 400 according to various example embodiments of the present disclosure, or may generate an input signal based on a user input. The touch detecting unit 433 may be configured to convert a pressure applied to a predetermined part of the display 431 or a change in a capacitance generated from a predetermined part of the display 431, into an electrical input signal. The touch detecting unit 433 may detect a location and an area where an input means (e.g., a user's finger, an electronic pen, or the like) touches or approaches the surface of the display 431. Also, the touch detecting unit 433 may be configured to detect even a pressure when a touch is given, based on an applied touching scheme. When a touch or proximity input with respect to the touch detecting unit 433 exists, a signal(s) corresponding thereto may be transferred to a touch screen controller (not illustrated). The touch screen controller (not illustrated) may process the signal(s), and may transfer the corresponding data to the controller 480. Accordingly, the controller 480 may be configured to determine an area of the touch screen 430 where a touch or proximity input is given, and may process the execution of a function corresponding thereto.

The audio processing unit 440 may include a configuration that is identical or similar to the audio module 280 of FIG. 2. The audio processing unit 440 may transmit an audio signal received from the controller 480 to a speaker (SPK) 441, and may transfer, to the controller 480, an audio signal such as a voice or the like, which is input from a microphone (MIC) 443. The audio processing unit 440 may convert voice/sound data into audible sound through the speaker 441 under the control of the controller 480 and may output the audible sound, and may convert an audio signal, such as a voice or the like, which is received from the microphone 443 into a digital signal and may transfer the digital signal to the controller 480. The audio processing unit 440 may output an audio signal that responds to a user input, based on audio processing information (e.g., sound effect, music file, or the like) included in data.

The speaker 441 may output audio data that is received from the wireless communication unit 410 or stored in the memory 450. The speaker 441 may output a sound signal associated with various operations (functions) executed by the electronic device 400. The speaker 441 may be in charge of outputting an audio stream, such as a voice recognition function, a digital recording function, a phone call function and the like. Although not illustrated in various example embodiments of the present disclosure, the speaker 441 may include an attachable and detachable ear phone, a head phone, or a head set, and they may be connected with the electronic device 400 through an external port.

The microphone 443 may receive an external sound signal and process the same as electrical voice data. The voice data that is processed through the microphone 443 may be output by being converted into a form that is transmittable to the outside through the mobile communication module 411 when the electronic device 400 is in a call mode. Various noise reduction algorithms may be implemented in the microphone 443 to remove noise generated in the process of receiving an external sound signal. The microphone 443 may be in charge of inputting an audio stream, such as a voice command (e.g., a voice command for initiating an image quality measuring operation of the electronic device 400), voice recognition, digital recording, phone call, and the like. For example, the microphone 443 may convert a voice signal into an electrical signal. According to various example embodiments of the present disclosure, the microphone 443 may include an embedded microphone that is contained in the electronic device 400 and an external microphone that is connected to the electronic device 400.

The memory 450 (e.g., the memory 130 and 230) may store one or more programs that are executed by the controller 480, and may execute a function for temporarily storing input/output data. The input/output data may include, for example, contents, messenger data (e.g., conversation data), contact information (e.g., wired or wireless phone number or the like), a message, a media file (e.g., an audio file, a video file, an image file, or the like), or the like. According to various example embodiments of the present disclosure, the memory 450 may store one or more images that are the target of an image quality evaluation and a plurality of classifiers that may be used for the image quality evaluation of the one or more images.

The memory 450 may store one or more programs and data in association with the execution of an image quality measuring function. For example, the memory 450 may store one or more programs that process an operation of obtaining an image, an operation of analyzing (recognizing) an image, an operation of classifying an image scene category, an operation of extracting image quality factor scores, an operation of selecting an image quality classifier corresponding to an image scene category, an operation of extracting a total image quality score using image quality factor scores and an image quality classifier, an operation of determining a total image scene category using an image scene category and a total image quality score, and the like, and may store data that is processed accordingly.

The memory 450 may store a frequency of the use (e.g., a frequency of the use of an image scene classifier, a frequency of the use of an image, a frequency of the use of an application, a frequency of the use of contents, and the like) in association with the operations of the electronic device 400, importance, and priority, together. The memory 450 may store data that is associated with vibrations and sounds of various patterns that are output in response to a touch input or a proximity input made on the touch screen 430. The memory 450 may continuously or temporarily store an Operating System (OS) of the electronic device 400, a program that is associated with controlling inputting and displaying through the touch screen 430, a program associated with controlling various operations (functions) of the electronic device 400, and various data generated by the operations of each program, and the like.

The memory 450 (e.g., the memories 130 and 230) may include an external memory (e.g., the external memory 234) or an embedded memory (e.g., the embedded memory 232). The electronic device 400 may also operate in relation to a web storage performing a storage function of the memory 450 on the Internet.

The memory 450 may store various software. For example, the component elements of software may include, an operating system software module, a communication software module, a graphic software module, a user interface software module, a Moving Picture Experts Group (MPEG) module, a camera software mode, or one or more application software modules, and the like. Further, since a module, which is a component element of software, may be expressed as a set of instructions, the module is also expressed as an instruction set. The module is also expressed as a program. According to various example embodiments of the present disclosure, the memory 450 may include an additional module (instructions) in addition to the above described modules. Alternatively, the memories may not use some modules (instructions) when necessary.

The operating system software module may include various software component elements that control a general system operation. The control of such general system operations refers to, for example, memory management and control, storage hardware (device) management and control, power management and control, and the like. Also, the operating system software module may execute a function that supports smooth communication between various hardware (devices) and software component elements (modules).

The communication software module may enable communication with another electronic device, such as a wearable device, a device, a computer, a server, a portable terminal, or the like, through the wireless communication unit 410 or the interface unit 460. The communication software module may be formed in a protocol structure corresponding to a corresponding communication scheme.

The graphic software module may include various software component elements for providing and displaying graphics on the touch screen 430. The term “graphics” may include, for example, text, a webpage, an icon, a digital image, a video, animation, and the like.

The user interface software module may include various software component elements associated with a user interface (UI). For example, the user interface software module may include the contents associated with how the state of the UI changes, a condition where a change of the state of the UI is made, or the like.

The MPEG module may include a software component element that enables processes and functions (e.g., generating, reproducing, distributing, and transmitting a content, or the like) that are associated with a digital content (e.g., video or audio).

The camera software module may include a camera software component element that enables camera related processes and functions.

The application module may include a web browser including a rendering engine, an email, an instant message, word processing, keyboard emulation, an address book, a touch list, a widget, digital right management (DRM), voice recognition, a position determining function, a location based service, and the like. According to various example embodiments of the present disclosure, the application module may include instructions for executing image quality measurement. For example, the application module may process an operation (function) that executes analyzing an input (obtained or photographed) image, classifying an image scene category of the analyzed image, extracting image quality factor scores, determining an image quality classifier corresponding to the classified image scene category, and determining a total image quality score using the image quality factor scores and the image quality classifier.

The interface unit 460 may include a configuration identical or similar to the interface 270 of FIG. 2. The interface unit 460 may serve as an interface with all external devices that are connected to the electronic device 400. The interface unit 460 may receive data or power from an external device and transmit the same to each component element of the electronic device 400, or may enable data inside the electronic device 400 to be transmitted to an external device. For example, the interface unit 460 may include a wired/wireless headset port, an external charger port, a wired/wireless data port, a memory card port, a port for connecting a device provided with an identification module, an audio input/output port, a video input/output port, an earphone port, and the like. According to various example embodiments of the present disclosure, the interface unit 460 may communicate with a device in a connected state that enables the electronic device 400 and the device to execute communication, so as to exchange various data (e.g., a control signal by a device, a response signal by the electronic device 400, an image signal, an audio signal, a file, and the like).

The camera module 470 (e.g., the camera module 291) may include a configuration that supports a photographing function of the electronic device 400. The camera module 470 may support photographing an image (a still image or a moving image) of a subject. The camera module 470 may photograph a subject under the control of the controller 480, and may transfer the photograph data to the display 431 and the controller 480. The camera module 470 may be configured to include an image sensor (or a camera sensor) (not illustrated) for converting an input optical signal into an electric signal, and an image signal processing unit (not illustrated) for converting the electric signal input from the image sensor into digital image data.

The image sensor may include a sensor using a Charge-Coupled Device (CCD) or a Complementary Metal-Oxide-Semiconductor (CMOS), or the like. Additionally or alternatively, the camera module 470 may include, for example, a color sensor for distinguishing colors by sensing a wavelength of light that an object radiates or reflects. The camera module 470 may support an image processing function that supports photographing according to various photographing options (e.g., out-of-focus, motion blur, zooming, a screen ratio, and effects (e.g., sketch, mono, sepia, vintage, mosaic, a picture frame, and the like)) based on the user's settings.

The controller 480 may be configured to control the general operations of the electronic device 400. For example, the controller 480 may be configured to execute a control associated with a voice communication, a data communication, a video communication, or the like. The controller 480 may include processing circuitry including one or more processors (e.g., the processor 210), or the controller 480 may be referred to as a processor. For example, the controller 480 may include a Communication Processor (CP), an Application Processor (AP), an interface (e.g., General Purpose Input/Output (GPIO)), an embedded memory, or the liker as separate component elements, or may integrate the above component elements as one or more integrated circuits. The application processor may execute various software programs and perform various functions for the electronic device 400, and the communication processor may execute a process and a control for the voice communication and data communication. Also, the controller 480 may execute a predetermined software module (instruction set) stored in the storage unit 450, and may execute various predetermined functions corresponding to the module.

According to various example embodiments of the present disclosure, the controller 480 may be configured to control an operation associated with executing an image quality measuring function. For example, the controller 480 may be configured to distinguish an image (e.g., an out-of-focus background image, a motion blur image, or the like) to which a special effect (e.g., out-of-focus, motion blur, or the like) is applied when an electronic device determines an image quality score in association with the image quality measurement. The controller 480 may be configured to measure an image quality by distinguishing each property of an image (e.g., an out-of-focus background image, a motion blur image, and the like), as described above. The controller 480 may be configured to classify the image based on an image scene category (e.g., mountain, ocean, sky, beach, streets, night view, or the like) and to determine an image scene classifier corresponding to the corresponding image scene category, in the image quality measurement. The controller 480 may be configured to determine an image quality by applying, to the image, a different weight based on the determined image scene classifier. According to various example embodiments of the present disclosure, when the controller 480 executes total image quality evaluation, the controller 480 may be configured to determine an image quality (e.g., may determine an image quality score) based on an image quality factor score determined based on the property of the image and an image scene category classifier. The operations of the controller 480, according to various example embodiments of the present disclosure, will be described with reference to the following drawings.

According to various example embodiments of the present disclosure, the controller 480 may be configured to work together with software modules stored in the memory 450, and may be configured to execute an image quality measuring function of the electronic device 400 according to various example embodiments of the present disclosure. According to various example embodiments of the present disclosure, the controller 480 may be embodied as one or more modules that are capable of processing the above described image quality measuring function. According to various example embodiments of the present disclosure, the controller 480 may be embodied as one or more processors that controls an operation (e.g., an operation of executing an image quality measuring function) of the electronic device 400, according to various example embodiments of the present disclosure, by executing one or more programs stored in the memory 450. For example, the controller 480 may be embodied to include a quality measuring module 485. According to various example embodiments of the present disclosure, the quality measuring module 485 may be embodied to include an image managing module, a category classifying module, an image factor extracting module, a classifier selecting module, an image quality evaluating module, and the like.

According to various example embodiments of the present disclosure, the quality measuring module 485 may be configured to measure the quality of an image. According to various example embodiments of the present disclosure, the controller 480 may be configured to control the execution of various operations by distinguishing a good image or a bad image in association with an image, based on the image quality evaluation by the quality measuring module 485. For example, the controller 480 may be configured to extract and remove a bad image from images stored in the electronic device 400 or an external device (e.g., another electronic device or a server), may be configured to provide the management of a memory by informing a user of an unnecessary image stored in the memory 450, and may be configured to propose candidate images (e.g., propose candidate images based on a good image) for image summarization. Detailed example configurations of the quality measuring module 485 and controlling operations thereof, according to various example embodiments of the present disclosure, will be described with reference to the following drawings.

The controller 480 according to various example embodiments of the present disclosure may be configured to control various operations associated with normal functions of the electronic device 400, in addition to the above described functions. For example, when a predetermined application is executed, the controller 480 may be configured to control an operation and displaying of a screen for the predetermined application. Also, the controller 480 may be configured to receive input signals corresponding to various touch event inputs or proximity event inputs that are supported by a touch-based or proximity-based input interface (e.g., the touch screen 430), and control operating functions corresponding thereto. Moreover, the controller 480 may also be configured to control data transmission/reception based on wired communication or wireless communication.

The power supply unit 490 may receive an external power or an internal power under the control of the controller 480, and may supply power that is required for the operation of each component element. According to various example embodiments of the present disclosure, the power supply unit 490 may turn on or off the power supplied to one or more processors of the controller 480, the display 431, the wireless communication unit 410, and the like, under the control of the controller 480.

Various example embodiments described in the present disclosure may be implemented in a computer (or similar device)-readable recording medium using software, hardware or a combination thereof. According to the hardware implementation, the various example embodiments of the present disclosure may be implemented using at least one of hardware circuitry, Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, micro-processors, and electrical units for performing other functions.

According to various example embodiments of the present disclosure, the recording medium may include a computer readable recording medium that stores a program for implementing an operation of classifying an image scene category of an image and determining a classifier corresponding to the classified image scene category, an operation of determining image quality factor scores of the image, an operation of executing image quality evaluation of the image using the image quality factor scores and the classifier.

In some examples, the embodiments described in the present specification may be implemented by the controller 480 itself. Furthermore, according to the software implementation, the example embodiments such as procedures and functions described in the present specification may also be implemented as separate software modules. The software modules may perform one or more functions and operations described in the present disclosure.

According to various example embodiments of the present disclosure, at least some of the functions executed by the electronic device 400 may be executed by an external device (e.g., the server 106) thereof. For example, the server 106 may include a processing module corresponding to the controller 480, may process, using the processing module, at least some of the functions associated with measuring the quality of an image of the electronic device 400 and controlling the execution of the function, based on at least some of the information transferred from the electronic device 400, and transmits a result of processing to the electronic device 400.

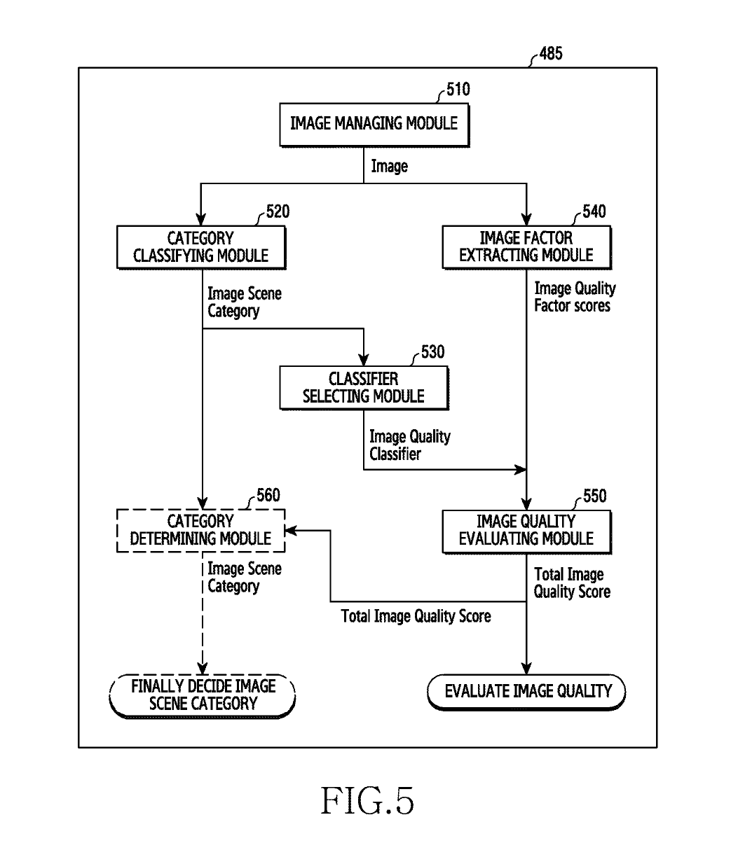

FIG. 5 is a diagram illustrating an example configuration for measuring the quality of an image in an electronic device.

Referring to FIG. 5, FIG. 5 schematically illustrates an example configuration of the quality measuring module 480 of the controller 480 as illustrated in FIG. 4. The quality measuring module 485, according to various example embodiments of the present disclosure, may include an image managing module 510 (e.g., a camera manager or an image manager), a category classifying module 520, a classifier selecting module 530, an image factor extracting module 540, and an image quality evaluating module 550. In various example embodiments of the present disclosure, the quality measuring module 485 may selectively further include a category determining module 560 or may omit the same. For example, in various example embodiments of the present disclosure, the quality measuring module 485 may include fewer or more component elements when compared to the component elements of FIG. 5, since the component elements of FIG. 5 are not prerequisite.

The image managing module 510 may obtain an image photographed through the camera module 470, an image stored in the memory 450, or an image received from an external device (e.g., another electronic device or a server). The image managing module 510 may recognize image information (e.g., an image file format) from an image obtained for measuring the quality of an image. The image managing module 510 may transfer at least some of the recognized image information or the image to the category classifying module 520 and the image factor extracting module 540. According to various example embodiments of the present disclosure, the image information may include, for example, Exchangeable Image File Format (EXIF) information, and may include, for example, various information, such as information associated with a date when an image is generated (photographed), size information, exposure time (shutter speed) information, location information, effects (e.g., out-of-focus, blur, motion blur, or the like) information, scene information, and the like.

The category classifying module 520 may classify an image scene category of the image based on at least some of the image or the image information transferred from the image managing module 510. For example, the category classifying module 520 may classify the category of the image by analyzing a type of scene that the image corresponds to, for example, mountain, ocean, sky, beach, streets, night view, or the like. According to an example embodiment of the present disclosure, the category classifying module 520 may define a type of scene (e.g., a category or a class) of an image through an image classifying method that classifies an image by quantizing feature vectors of an image or an image classifying method that classifies an image using deep learning An image classifying method that quantizes a feature vector of the image may, for example, extract a feature vector (e.g., a feature point of a corner, a color, letters, a sentence, a specific shape, a behavior pattern, statistics, or the like), quantizes the feature vector, and measures likeness to a predetermined scene category that is stored in advance, using the similarity of a cumulative histogram of the feature vector. The image classifying method using deep learning may define a class of an image by attempting, for example, a high level abstraction (which abstracts main contents or functions from a large amount of data or complex materials) through the combination of various non-linear conversion schemes. The category classifying module 520 may transfer the classified image scene category of the image to the classifier selecting module 530.

The classifier selecting module 530 may select (determine) a classifier (e.g., an image quality classifier) corresponding to the image scene category that is transferred from the category classifying module 520. For example, the classifier selecting module 530 may select a classifier corresponding to the transferred image scene category of the image (e.g., mountain, ocean, sky, beach, streets, night view, or the like), out of image quality classifiers stored in advance. According to various example embodiments of the present disclosure, the classifier may indicate a reference value that is used for differentially measuring quality based on an image scene category of a corresponding image when the classifier measures the quality of the image.

According to an example embodiment of the present disclosure, in a case of a night view image (e.g., image scene category=night view), although the image (picture) has a good quality, the image may have the features of low brightness and low exposure. Also, in a case of a cloud image (e.g., an image scene category=cloud), although the image (picture) has a good quality, a blur factor score may be low due to a unique frequency feature of the cloud. Therefore, when the quality of an image is measured, the quality may be measured from a different perspective view based on an image scene category. Accordingly, in various example embodiments of the present disclosure, the classifier selecting module 530 may change an image quality classifier to correspond to an image scene category, and thereby changing a perspective of measurement. For example, the classifier selecting module 530 may select and provide an image quality classifier that is appropriate for a night view image in a case of a night view image, and may select and provide an image quality classifier that is appropriate for a sky (cloud) image. The classifier selecting module 530 may transfer, to the image quality evaluating module 550, an image quality classifier that is determined for the image.

The image factor extracting module 540 may extract image quality factor scores with respect to the image based on at least some of an image or image information that is transferred from the image managing module 510. For example, the image factor extracting module 540 may extract an image quality factor such as sharpness, noise, contrast, color accuracy, distortion, blur, or the like of the image, measure the extracted image quality factor, and determine a score of each image quality factor. The image factor extracting module 540 may transfer, to the image quality evaluating module 550, the image quality factor scores that are determined for the image.

According to various example embodiments of the present disclosure, when the image includes special effects (e.g., out-of-focus, motion blur, or the like), the quality of the image may be measured from a different perspective.

According to an example embodiment of the present disclosure, in a case of an out-of-focus background image, although the image has a good quality, an area that is in focus may be insufficient. In this example, a blur factor score may increase. Therefore, according to various example embodiments of the present disclosure, the image factor extracting module 540 may divide an image into a plurality areas, and measures a blur factor score for each divided area. The image factor extracting module 540 may measure a blur factor score with respect to the sharpest area (or the sharpest group of a predetermined areas) from among blur factor scores of the areas. According to an example embodiment of the present disclosure, the image factor extracting module 540 may determine at least some areas (e.g., the sharpest area) out of the areas based on a result of measuring a blur factor score for each area, and may determine a blur factor score for evaluating the quality of an image based on the at least some area.

Also, in a case of a blur image, the corresponding score may be low. In a case of an image of which the entire area is sharp, or an out-of-focus background image, the corresponding score may be relatively high. Therefore, in a case of the sharp image, the blur image, or the out-of-focus image, this may be used as an image factor that has a high differentiation.

Conversely, in a case of the motion blur image, a sharp area in the image is low, and thus, a blur factor score may have a low differentiation with respect to the motion blur image. In a case of the motion blur image, an edge component does not exist in a motion direction in the image, and most edge components exist in a direction that is perpendicular to the motion direction. Therefore, a distribution of edge components for each motion direction (e.g., a distribution of vertical edge components and a distribution of vertical edge components) is extracted, and when a difference in cumulative edge distributions between orthogonal directions is larger, it is determined that a corresponding area belongs to a blur area by a motion blur.

According to various example embodiments of the present disclosure, the image factor extracting module 540 may extract a distribution of vertical edge components and a distribution of horizontal edge components, and may measure a blur factor score based on an area in which a difference in cumulative edge distributions between orthogonal directions is high. For example, in various example embodiments of the present disclosure, the image factor extracting module 540 may determine a target area of measurement for measuring a blur factor score, based on a difference in cumulative edge distributions between orthogonal directions (e.g., a difference between cumulative edge distributions of vertical edge components and horizontal edge components that are perpendicular thereto, or a difference between cumulative edge distributions of horizontal edge components and vertical edge components that are perpendicular thereto). For example, the image factor extracting module 540 extracts a distribution of edge components for each direction from the image, and determines the target area of measurement for measuring a blur factor score for evaluating the quality of the image based on an area having a large difference in cumulative edge distributions from among areas where a horizontal edge component and a vertical edge component are perpendicular to each other. According to an example embodiment of the present disclosure, as a difference in cumulative edge distributions between orthogonal directions is low, an image corresponds to an image where blur does not exist. As a difference in cumulative edge distributions between orthogonal directions is high, an image corresponds to an image where a motion blur exists.

The image quality evaluating module 550 (e.g., a total image quality evaluator) may extract a total image quality score with respect to the image using the image quality factor scores transferred from the image factor extracting module 540 and the image quality classifier transferred from the classifier selecting module 530. For example, the image quality evaluating module 550 may extract a likelihood score between a low quality image class and a high quality image class, using the image quality classifier based on the image quality factor scores. According to various example embodiments of the present disclosure, the extraction of the likelihood score may be an example of a score-based determination scheme that does not overestimate or underestimate reliability with respect to the image, but executes accurate determination. According to an example embodiment of the present disclosure, the image quality evaluating module 550 may compare learning data stored in advance and the image that is the target of image quality evaluation, and may determine a similarity (reliability) between the image and the learning data. According to various example embodiments of the present disclosure, the learning data may include sample data corresponding to a high-quality image and a low-quality image, which are stored by learning various images in advance.

According to various example embodiments of the present disclosure, the learning data used by the image quality evaluation module 550 may be learning data of images included in an image scene category that is classified by the category classifying module 520, and the images included in the image scene category may be classified into a high-quality image and a low-quality image based on an image quality classifier selected by the classifier selecting module 530. According to various example embodiments of the present disclosure, the image quality evaluating module 550 may compare the image and the images of the learning data, and may extract a likelihood score of the image based on learning data having a high reliability. For example, the image quality evaluating module 550 may estimate the likelihood score of the image based on the learning data that is distinguished based on the image quality factor scores and the determined classifier.

The image quality evaluating module 550 may determine a total image quality score with respect to the image, based on the extracted likelihood score. The image quality evaluating module 550 may manage an image quality score of the image, based on the determined total image quality score. For example, the image quality evaluating module 550 may provide the image quality score to a function (application) executed in the electronic device 400 using the evaluation of an image (e.g., removing a bad image, managing a memory, proposing candidate images for abstracting an image, or the like).

The category determining module 560 may determine (decide) an image scene category of the image using the image scene category transferred from the category classifying module 520 and the total image quality score transferred from the image quality evaluating module 550. For example, when the quality of an original image is bad, it is better to not classify the image to a predetermined category from the perspective of precision. Therefore, the category determining module 560 may finally determine the image scene category of the image, based on the total image quality score.

According to various example embodiments of the present disclosure, the image scene category classified in association with the image in the category classifying module 520 and the image scene category finally decided in the category determining module 560 may be determined to be an identical image scene category based on the total image quality score, or may be determined as a detailed image scene category. For example, it is assumed that the category classifying module 520 classifies the image scene category as a “sky” category, the category determining module 560 may finally decide the image scene category of the image as the “sky” category when the total image quality score is determined to be within a predetermined range of a predetermined reference value. Also, when the total image quality score is determined to be higher than the predetermined range of the predetermined reference value, the category determining module 560 may finally determine the image to be a “clear sky” category. When the total image quality score is determined to be lower than the predetermined range of the predetermined reference value, the category determining module 560 may classify the image as a “cloudy sky” category. As described above, the category determining module 560 may classify the image scene category as a detailed category. The category determining module 560 may update the image scene category of the image based on the finally decided image scene category, when the image scene category is finally decided. Subsequently, in a process of evaluating the quality of an image, the image scene category of the image may be classified to correspond to the finally decided image scene category.

According to various example embodiments of the present disclosure, the configuration of the category determining module 560 may be excluded.

As described above, the electronic device 400 may include the memory 450 that stores a plurality of images and a plurality of classifiers; and a processor (e.g., the controller 480) that is electrically connected with the memory 450, wherein the processor is configured to: analyze a category of an image of which image quality evaluation is requested, and determine a classifier corresponding to the category of the image from among the plurality of classifiers; determine image quality factor scores of the image; and evaluate the image quality of the image based on the determined image quality factor scores and the determined classifier.

In various example embodiments of the present disclosure, the processor (e.g., the controller 480) may include: the image factor extracting module 540 that measures the quality for each image quality factor of the image; the category classifying module 520 that classifies an image scene category of the image; the classifier selecting module 530 that selects an image quality classifier corresponding to the image scene category; and the image quality evaluating module 550 that determines the total image quality score of the image based on results from the image factor extracting module 540 and the classifier selecting module 530.

The category classifying module 520 may analyze the image scene category based on a scheme that classifies an image using feature vectors of the image or a scheme that classifies an image using deep learning.

The classifier selecting module 530 may select a classifier corresponding to the image scene category from among image quality classifiers stored in advance in the memory 450.

According to various example embodiments of the present disclosure, the image factor extracting module 540 divides the image into a plurality of areas, and measures a blur factor score for each divided area, and measures a blur factor score for evaluating an image quality in at least one of the areas based on a result of measuring the blur factor score for each area. The image factor extracting module 540 performs: measuring a blur factor score for each of the divided areas of the image, and determining, as a target area of measurement, one or more areas that have a high sharpness out of the divided areas, wherein the target area of measurement includes a predetermined area or a group of a predetermined number of adjacent areas, which has a low blur factor score out of the divided areas.

According to various example embodiments of the present disclosure, the image factor extracting module 540 extracts, from the image, a distribution of edge components for each direction, and measures a blur factor score for image quality evaluation based on an area that has a large difference in cumulative edge distributions from among areas where a horizontal edge component and a vertical edge component are perpendicular to each other.

The image quality evaluating module 550 extracts a likelihood score corresponding to the image, using image quality factor scores that are transferred from the image factor extracting module 540 and the image quality classifier transferred from the classifier selecting module 530, and determines a total image quality score with respect to the image based on the extracted likelihood score.

According to various example embodiments of the present disclosure, the processor (e.g., the controller 480) may include the image managing module 510 that obtains the image from the inside or the outside, and recognizes image information for measuring the quality of the image. According to various example embodiments of the present disclosure, the processor (e.g., the controller 480) may include the category determining module 560 that finally decides the image scene category with respect to the image, using the image scene category transferred from the category classifying module 520 and the total image quality score transferred from the image quality evaluating module 550.

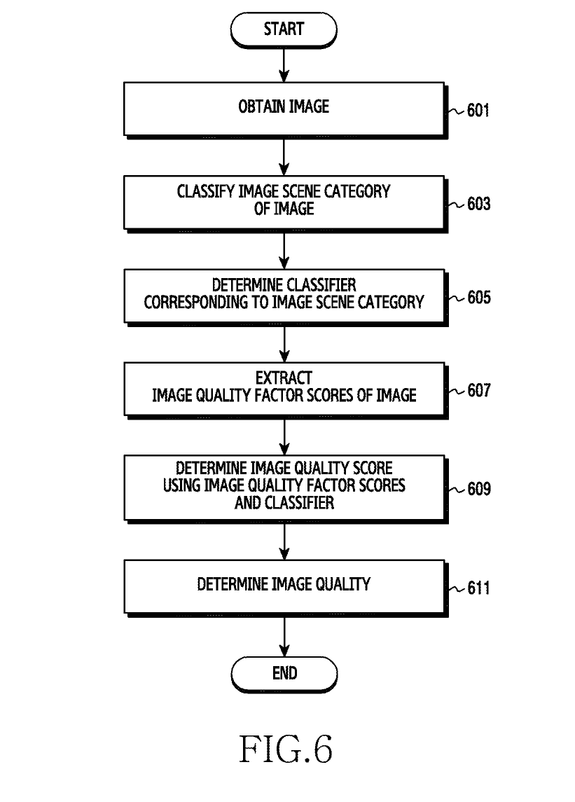

FIG. 6 is a flowchart illustrating an example image quality measuring method in an electronic device.

Referring to FIG. 6, in operation 601, the controller 480 is configured to obtain an image. For example the controller 480 (e.g., the image managing module 510) may obtain an image photographed using the camera module 470, an image stored in the memory 450, an image received from an external device (e.g., another electronic device or a server), or the like, in response to a user's request.

In operation 603, the controller 480 may be configured to classify an image scene category of the obtained image. For example, the controller 480 (e.g., the category classifying module 520) may be configured to analyze an image scene that the obtained image corresponds to, for example, mountain, ocean, sky, beach, streets, night view, or the like, and may be configured to classify the category of the image based on a result of the analysis. According to various example embodiments of the present disclosure, the controller 480 may be configured to classify the image through various algorithms, such as an image classifying scheme that quantizes a feature vector of an image, an image classifying scheme that uses deep learning, or the like.

In operation 605, the controller 480 may be configured to determine a classifier corresponding to the classified image scene category. For example, the controller 480 (e.g., the classifier selecting module 530) may be configured to select a classifier corresponding to the image scene category from among various image quality classifiers stored in advance in the memory 450. For example, the controller 480 may be configured to select an image quality classifier corresponding to a night view image when the image scene category of the image is night view, and may select an image quality classifier corresponding to a sky image when the image scene category of the image is sky (cloud).

In operation 607, the controller 480 may be configured to extract image quality factor scores of the obtained image. For example, the image may include various image quality factors, such as sharpness, noise, contrast, color accuracy, distortion, blur, or the like, and the controller 480 (e.g., the image factor extracting module 540) may be configured to extract the various image quality factors from the image. The controller 480 (e.g., the image factor extracting module 540) may be configured to measure the extracted image quality factors so as to determine scores of each image quality factor.

According to various example embodiments of the present disclosure, the controller 480 (e.g., the image factor extracting module 540) may be configured to determine the scores of image quality factors, with respect to a special image to which special effects are applied by user's intention, such as an out-of-focus image, a motion blur image, or the like, and the scores may be determined by applying a weight to the corresponding image, as opposed to using the score determination based on a general blur factor. According to various example embodiments of the present disclosure, an operation of measuring a blur factor of the corresponding image by distinguishing the out-of-focus image or the motion blur image will be described.

In various example embodiments of the present disclosure, although it has been described that the image scene category classifying operation of operation 603 is executed before the image quality factor score extracting operation of operation 607, this is merely for ease of description, the operations may not always be executed in this order. For example, according to various example embodiments of the present disclosure, operation 607 may be executed before operation 603, or operation 603 and operation 607 may be executed in parallel.

In operation 609, the controller 480 may determine image quality scores of the image. For example, the controller 480 (e.g., the image quality evaluating module 550) may be configured to determine an image quality score of the image using the scores of the image quality factors of the image and the classifier selected for the image. According to various example embodiments of the present disclosure, the operation of determining the image quality scores will be described with reference to the drawing to be described below.

In operation 611, the controller 480 determines and provides the quality of the image based on the image quality scores.

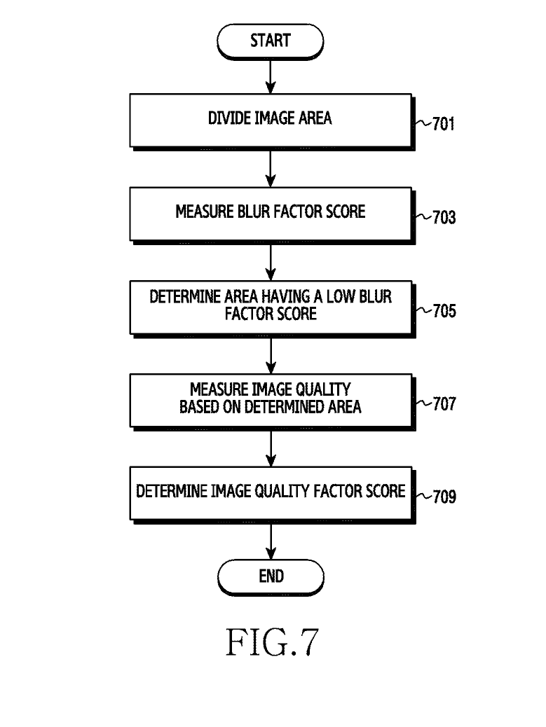

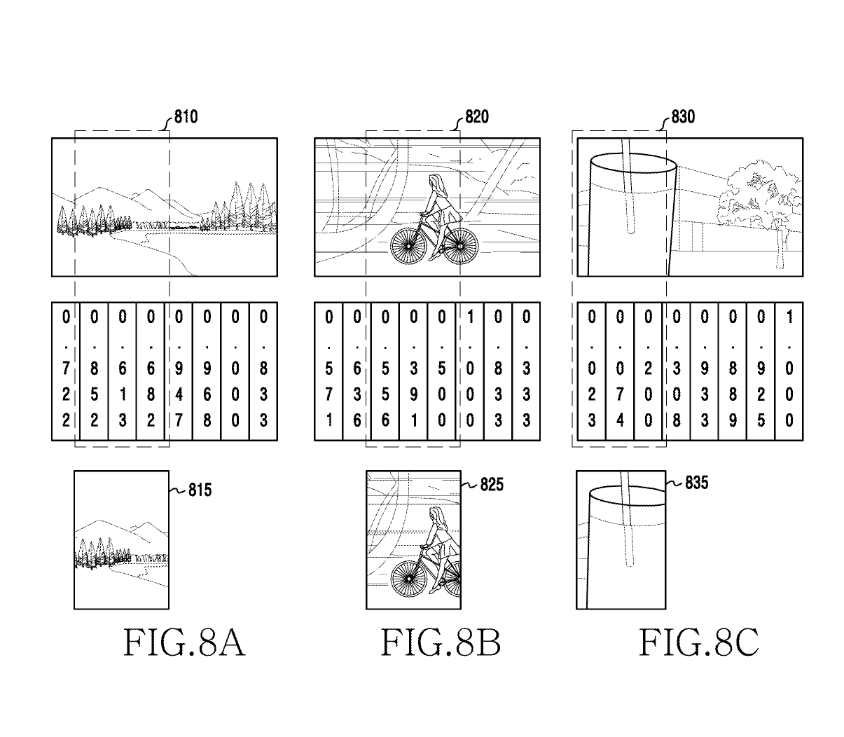

FIG. 7 is a flowchart illustrating an example of measuring an image quality factor of a special image in an electronic device. FIGS. 8A to 8C are diagrams illustrating examples of an operation of extracting a quality factor of an out-of-focus image in an electronic device.

FIG. 7 is a flowchart illustrating an example of an operation of extracting, from a special image, an area (e.g., a sharp area to which out-of-focus is not applied (an area being in focus)) remaining after excluding an out-of-focus background, and measuring the quality when the special image is an out-of-focus image.

In operation 701, the controller 480 is configured to divide an image area. For example, the controller 480 (e.g., the image factor extracting module 540) may be configured to divide the image into a plurality of areas based on a number that is adaptively determined to correspond to a set number or the size of an image. According to various example embodiments of the present disclosure, the image division may be vertical division, horizontal division, or vertical and horizontal division (lattice form). The example is illustrated in FIG. 8.

FIG. 8 is a diagram illustrating an example of extracting an out-of-focus background factor, in an operation of measuring an image quality factor with respect to an out-of-focus image. As illustrated in FIGS. 8A, 8B, and 8C, FIGS. 8A to 8C illustrate examples of vertically dividing an image into 8 areas. According to various example embodiments of the present disclosure, the division is virtual division for extracting a target area for measuring the quality, but does not change the properties of the image itself.

Referring again to FIG. 7, in operation 703, the controller 480 may be configured to measure a blur factor score based on a plurality of divided areas. For example, the controller 480 (e.g., the image factor extracting module 540) may be configured to measure a score of a blur factor out of the image quality factors for each of the divided areas. For example, as illustrated in FIGS. 8A, 8B, and 8C, a blur factor score may be measured for each of 8 divided areas. According to an example embodiment of the present disclosure, FIG. 8A illustrates an example in which a blur factor score of a first divided area is measured as 0.722, a blur factor score of a second divided area is measured as 0.852, a blur factor score of a third divided area is measured as 0.613, a blur factor score of a fourth divided area is measured as 0.682, a blur factor score of a fifth divided area is measured as 0.947, a blur factor score of a sixth divided area is measured as 0.968, and a blur factor score of a seventh divided area is measured as 1.000, and a blur factor score of an eighth divided area is measured as 0.833.

In operation 705, the controller 480 may be configured to determine an area having a low blur factor score. For example, the controller 480 (e.g., the image factor extracting module 540) may be configured to determine an area having the lowest blur factor score, based on a result of the blur factor score measurement executed for each of the 8 divided areas. In a case of an out-of-focus image, the image is photographed by intending to be out-of-focus, and thus, an out-of-focus background corresponding to a blur area may be included. Therefore, in the case of the out-of-focus image, the image has a high quality, an area that is in focus may be insufficient. In this instance, a blur factor score may increase. Therefore, according to various example embodiments of the present disclosure, the out-of-focus image is divided, and a blur factor score may be determined based on one or more areas (e.g., an area being in focus) having a high sharpness.

According to various example embodiments of the present disclosure, a target area of measurement for measuring a blur factor score may be determined, and the target area of measurement may be determined based on an area having the lowest blur factor score out of the divided areas, a predetermined number of adjacent areas (hereinafter, a group area) having the lowest sum of blur factor scores, or the like. For example, according to various example embodiments of the present disclosure, the target area of measurement may be determined based on a group of 3 divided areas out of the 8 divided areas, for example, the first through eighth divided areas. According to an example embodiment of the present disclosure, as illustrated in FIG. 8, the controller 480 may be configured to determine a blur factor score of a first group area (e.g., the first divided area, the second divided area, and the third divided area) by, for example, adding blur factor scores of the first divided area and consecutive two other divided areas (e.g., the second divided area and the third divided area), and may determine a blur factor score of a second group area (e.g., the second divided area, the third divided area, and the fourth divided area) by, for example, adding blur factor scores of the second divided area and consecutive two other divided areas (e.g., the third divided area and the fourth divided area). The controller 480 may be configured to determine a group-based (e.g., a total of 6 groups) blur factor score with respect to all of the divided areas.

According to various example embodiments of the present disclosure, the controller 480 may be configured to determine a group-based blur factor score as described above, and may be configured to determine, as a target area of measurement, the areas of a group having the lowest blur factor score (e.g., as a blur factor score becomes lower, sharpness becomes higher, and as a blur factor score becomes higher, sharpness becomes lower and an area corresponds to a blur image). For example, in a case of FIG. 8A, a blur factor score of a group area 810 of a second divided area (0.852), a third divided area (0.613), and a fourth divided area (0.682) has the lowest blur factor score. In a case of FIG. 8B, a blur factor score of a group area 820 of a third divided area (0.556), a fourth divided area (0.391), and a fifth divided area (0.500) has the lowest blur factor score. In a case of FIG. 8C, a blur factor score of a group area 830 of a first divided area (0.023), a second divided area (0.023), and a third divided area (0.200) has the lowest blur factor score.

In operation 707, the controller 480 may be configured to re-measure an image quality (e.g., measuring a blur factor score), based on an area (or group area) determined in operation 705. For example, the controller 480 may be configured to measure the image quality, based on the target area of measurement, which is determined in operation 705, as opposed to based on all of the areas of the image. According to an example embodiment of the present disclosure, the controller 480 (e.g., the image factor extracting module 540) may be configured to measure an image quality with respect to an image part 815 included in the group area 810 of an image in FIG. 8A. In FIG. 8B, the controller 480 may be configured to measure an image quality with respect to an image part 825 included in the group area 820 of an image. In FIG. 8C, the controller 480 may be configured to measure an image quality with respect to an image part 835 included in the group area 830 of an image. For example, according to various example embodiments of the present disclosure, a target area of measurement having a high sharpness may be distinguished by dividing the out-of-focus image into areas, and a blur factor score may be re-measured based on the distinguished target area of measurement.

In operation 709, the controller 480 may be configured to determine and provide an image quality factor score (e.g., a blur factor score) of the image, based on the measurement of an image quality with respect to the target area of measurement.

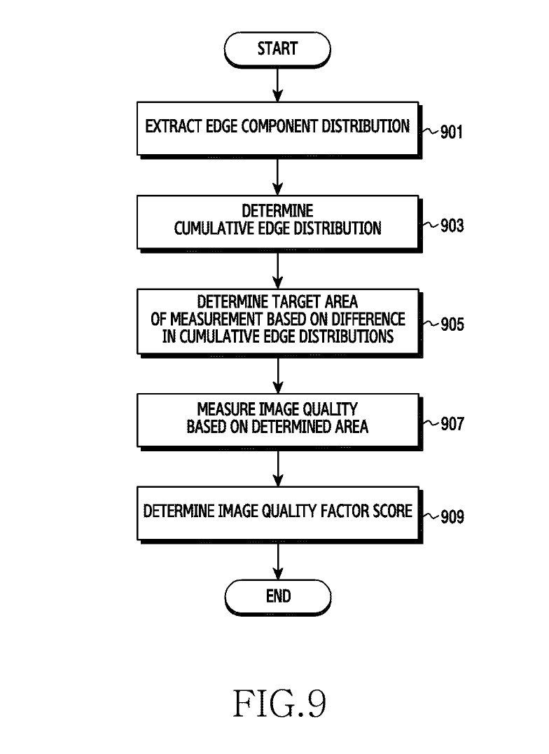

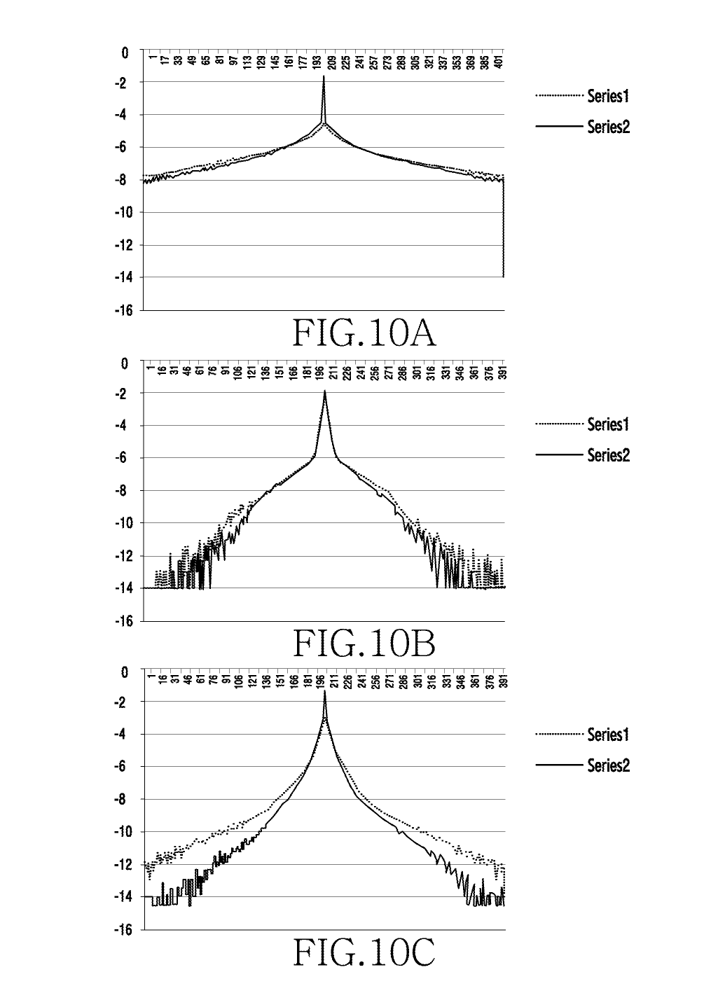

FIG. 9 is a flowchart illustrating an example of an operation of measuring an image quality factor of a special image in an electronic device. FIGS. 10A to 10C are diagrams illustrating examples of an operation of extracting a quality factor of a motion blur image in an electronic device.

Referring to FIG. 9, FIG. 9 is a flowchart illustrating an example of an operation of measuring quality by extracting a motion blur area from a special image when the special image is a motion blur image.

In operation 901, the controller 480 is configured to extract an edge component distribution from an image. For example, in a case of the motion blur image, a sharp area in the image is low, and thus, a blur factor score may have a low differentiation with respect to the motion blur image. According to an example embodiment of the present disclosure, in a case of the motion blur image, an edge component does not exist in a motion direction in the image, and most edge components exist in a direction that is perpendicular to the motion direction. According to various example embodiments of the present disclosure, the controller 480 (e.g., the image factor extracting module 540) may be configured to extract an edge component distribution for each direction (e.g., vertical direction and horizontal direction).

In operation 903, the controller 480 may be configured to determine a cumulative edge distribution based on the edge component distribution extracted for each direction. For example, the controller 480 (e.g., the image factor extracting module 540) may be configured to determine an area (hereinafter, a target area of decision) that includes the largest edge components in the image.

In operation 905, the controller 480 may be configured to determine a target area of measurement, based on a difference in cumulative edge distributions. For example, the controller 480 (e.g., the image factor extracting module 540) may be configured to determine a target area of measurement out of the target area of decision, based on a difference in cumulative edge distributions between orthogonal directions (e.g., a difference between cumulative edge distributions of vertical edge components and horizontal edge components that are perpendicular thereto, or a difference between cumulative edge distributions of horizontal edge components and vertical edge components that are perpendicular thereto). For example, the controller 480 may be configured to extract a distribution of edge components for each direction from the image, and to determine the target area of measurement for measuring a blur factor score for evaluating an image quality based on an area having a large difference in cumulative edge distributions from among areas where a horizontal edge component and a vertical edge component are perpendicular to each other. According to an example embodiment of the present disclosure, as a difference in cumulative edge distributions between orthogonal directions is low, an image corresponds to an image where blur does not exist. As a difference in cumulative edge distributions between orthogonal directions is high, an image corresponds to an image where a motion blur exists. The example is illustrated in FIG. 10.

FIG. 10 is a diagram illustrating an example of a motion gradient histogram of an image. FIG. 10A illustrates an example of a gradient histogram corresponding to a non-blurred image. FIG. 10B illustrates an example of a gradient histogram corresponding to a blurred image. FIG. 10C illustrates an example of a gradient histogram corresponding to a motion-blurred image.

As illustrated in the gradient histogram of FIG. 10A, in a case of a non-blurred image, a difference between a vertical edge component (e.g., series 1) and a horizontal edge component (e.g., series 2) is little. As illustrated in the gradient histogram of FIG. 10B, in a case of a blurred image, a difference between a vertical edge component (e.g., series 1) and a horizontal edge component (e.g., series 2) is greater than the case A. As illustrated in the gradient histogram of FIG. 10C, in a case of a motion-blurred image, a difference between a vertical edge component (e.g., series 1) and a horizontal edge component (e.g., series 2) is greater than the case B. According to various example embodiments of the present disclosure, the electronic device 400 (e.g., the image factor extracting module 540) extracts a distribution of edge components for each motion direction (e.g., a distribution of vertical edge components and a distribution of vertical edge components), and determines that a corresponding area belongs to a blurred area by a motion blur when a difference in cumulative edge distributions between orthogonal directions is large.

Referring again to FIG. 9, in operation 907, the controller 480 may be configured to measure an image quality based on the area (target area of measurement) determined in operation 905. For example, the controller 480 (e.g., the image factor extracting module 540) may be configured to determine an image for each of FIGS. 10A, 10B, and 10C, and may be configured to measure the image quality based on the target area of measurement when it is determined that the determined image corresponds to a motion blur image. According to an example embodiment of the present disclosure, the controller 480 (e.g., the image factor extracting module 540) may be configured to measure the image quality based on the target area of measurement (e.g., an area having a large difference in cumulative edge distributions between orthogonal directions), which is determined in operation 905, as opposed to all of the areas of the image. For example, according to various example embodiments of the present disclosure, the target area of measurement may be distinguished out of the motion blur image, and a blur factor score may be re-measured based on the distinguished target area of measurement.

In operation 909, the controller 480 may be configured to determine an image quality factor score (e.g., a blur factor score) of the image, based on the measurement of an image quality with respect to the target area of measurement.

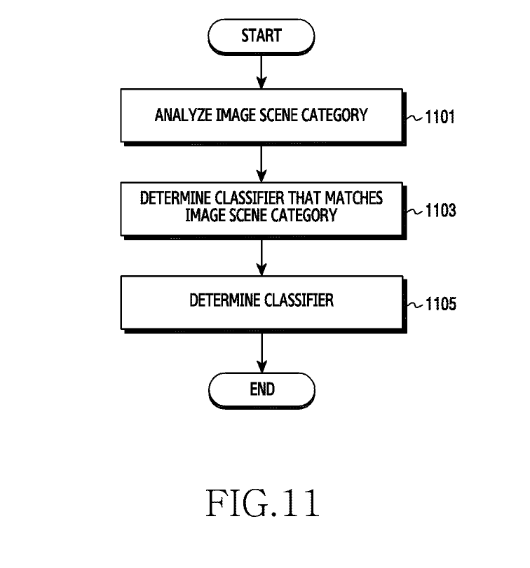

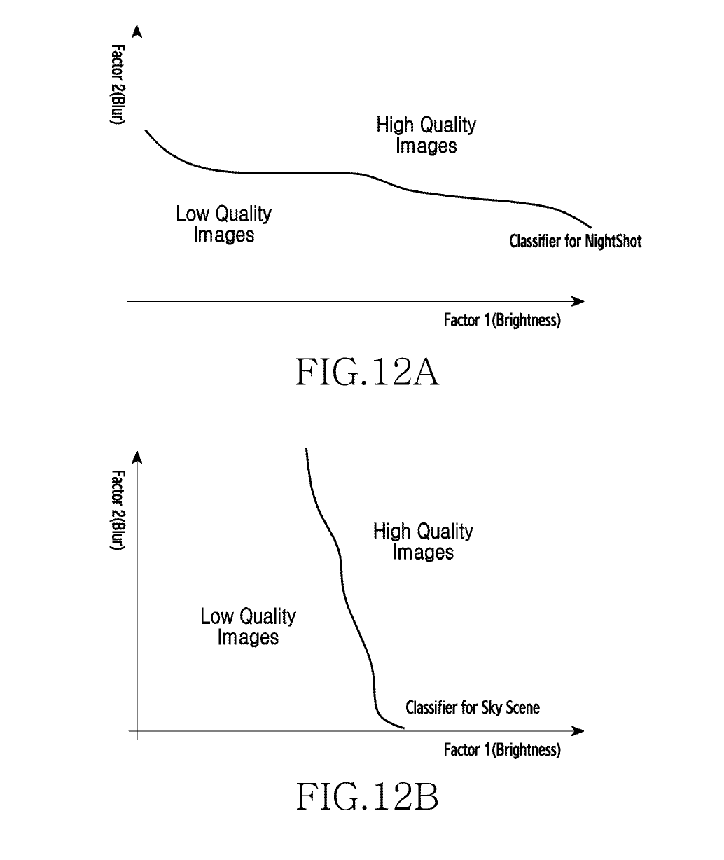

FIG. 11 is a flowchart illustrating an example of an operation of determining an image quality classifier in an electronic device. FIGS. 12A and 12B are diagrams illustrating examples of an image quality classifier in an electronic device.

Referring to FIG. 11, the controller 480 may be configured to analyze an image scene category in operation 1101, and to determine a classifier that matches the image scene category in operation 1103. For example, in a case of a night view image, the image may have a feature of a low brightness and a low exposure irrespective of whether the image has a good quality. Also, in a case of a sky (cloud) image, a blur factor score may be measured to be low due to a unique frequency feature of cloud, irrespective of whether the image has a good quality. Therefore, according to various example embodiments of the present disclosure, the controller 480 (e.g., the classifier selecting module 530) may be configured to analyze an image scene category of the image, and may be configured to measure an image quality by taking into consideration the image scene category. According to various example embodiments of the present disclosure, an image quality classifier corresponding to an image scene category may be defined in advance. The example is illustrated in FIG. 12.

FIG. 12A illustrates an example of a classifier that is applied when the image scene category is classified as a night view. FIG. 12B illustrates an example of a classifier that is applied when the image scene category is classified as sky.

According to an example embodiment of the present disclosure, in a case of a night view image, the image has a feature of a low brightness and a low exposure, irrespective of the quality, and thus, a brightness factor (or an exposure factor) score may be measured to be low, and also may be greatly affected by a blur factor. Therefore, according to various example embodiments of the present disclosure, as illustrated in FIG. 12A, a classifier that distinguishes an image quality based on a blur factor rather than a brightness (exposure) factor, may be provided for the night view image. For example, images corresponding to the part over the classifier (e.g., Classifier for NightShot in FIG. 12A) may be determined to be high quality images, and images corresponding the part under the classifier may be determined to be low quality images.

According to an example embodiment of the present disclosure, in a case of a sky image, due to a unique frequency feature, a blur factor score may be measured to be low and may be greatly affected by a brightness factor. Therefore, according to various example embodiments of the present disclosure, as illustrated in FIG. 12B, a classifier that may distinguish an image quality based on a brightness factor rather than a blur factor, may be provided for the sky image. For example, images corresponding to the part on the left of the classifier (e.g., Classifier for Sky Scene in FIG. 12B) may be determined to be low quality images, and images corresponding to the part on the right of the classifier may be determined to be high quality images.

Referring again to FIG. 11, in operation 1105, the controller 480 may be configured to determine a classifier that is appropriate for measuring the image quality. For example, the controller 480 (e.g., the classifier selecting module 530) may be configured to determine an image quality classifier to be different for each image scene category, as described above. For example, a classifier for a night view image and a classifier for a sky image may be provided to be different.

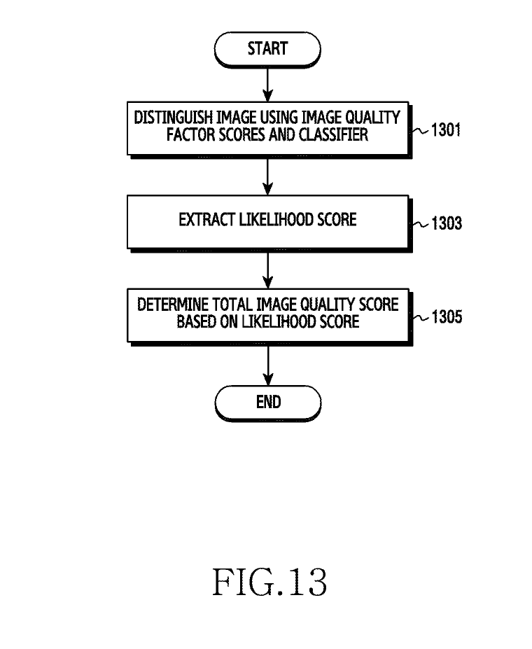

FIG. 13 is a flowchart illustrating an example method of measuring the quality of an image in an electronic device.

Referring to FIG. 13, in operation 1301, the controller 480 may be configured to distinguish an image using image quality factor scores and a classifier. For example, the controller 480 (e.g., the image quality evaluating module 550) may be configured to use an image quality classifier based on the image quality factor scores, and thus, may distinguish a high quality image class and a low quality image class, as illustrated in FIG. 12.

In operation 1303, the controller 480 may be configured to extract a likelihood score between a low quality image and a high quality image, based on distinguishing an image. According to various example embodiments of the present disclosure, the extraction of the likelihood score may be an example of a score-based determination scheme that does not overestimate or underestimate reliability with respect to the image, but executes accurate determination. For example, the controller 480 may be configured to compare learning data stored in advance and the image that is a target of image quality evaluation, and may determine a similarity (reliability) between the image and the learning data.

According to various example embodiments of the present disclosure, the learning data may include sample data corresponding to a high-quality image and a low-quality image, which are stored by learning various images in advance. According to various example embodiments of the present disclosure, the learning data used by the image quality evaluating module 550 may be learning data of images included in an image scene category that is classified by the category classifying module 520, and the images included in the image scene category may be classified as a high-quality image or a low-quality image based on an image quality classifier selected by the classifier selecting module 530.

According to various example embodiments of the present disclosure, the controller 480 may be configured to compare the image and the images of the learning data, and may extract a likelihood score of the image based on learning data having a high reliability. For example, the controller 480 may be configured to estimate the likelihood score of the image based on the learning data that is distinguished based on the image quality factor scores and the determined classifier.

In operation 1305, the controller 480 may be configured to determine a total image quality score with respect to the image, based on the extracted likelihood score.

As described above, an image quality evaluating method of the electronic device 400, according to various example embodiments of the present disclosure, may include: obtaining an image; classifying an image scene category of the image; determining a classifier corresponding to the classified image scene category; determining image quality factor scores with respect to the image; and executing image quality evaluation with respect to the image, using the determined image quality factor scores and the determined classifier.

According to various example embodiments of the present disclosure, the determining of the image quality factor scores includes: dividing the image into a plurality of areas; measuring a blur factor score for each of the plurality of divided areas; determining an area that has a low blur factor score; and executing image quality measurement based on the determined area. According to various example embodiments of the present disclosure, the determining of an area having a low blur factor score includes: determining, as a target area of measurement, one or more areas having a high sharpness out of the divided areas of the image, wherein the target area of measurement includes a predetermined area or a group of a predetermined number of adjacent areas, which has a low blur factor score out of the divided areas.

According to various example embodiments of the present disclosure, the determining of the image quality factor scores includes: extracting, from the image, a distribution of edge components for each direction; determining a cumulative edge distribution based on the extracted distribution of edge components for each direction; determining a target area of decision that includes the largest number of edge components; determining, from the target area of decision, a target area of measurement based on a difference in cumulative edge distributions; and executing image quality measurement based on the target area of measurement. According to various example embodiments of the present disclosure, the determining of the target area of measurement includes determining the target area of measurement based on a difference in cumulative edge distributions between orthogonal directions in the target area of decision.

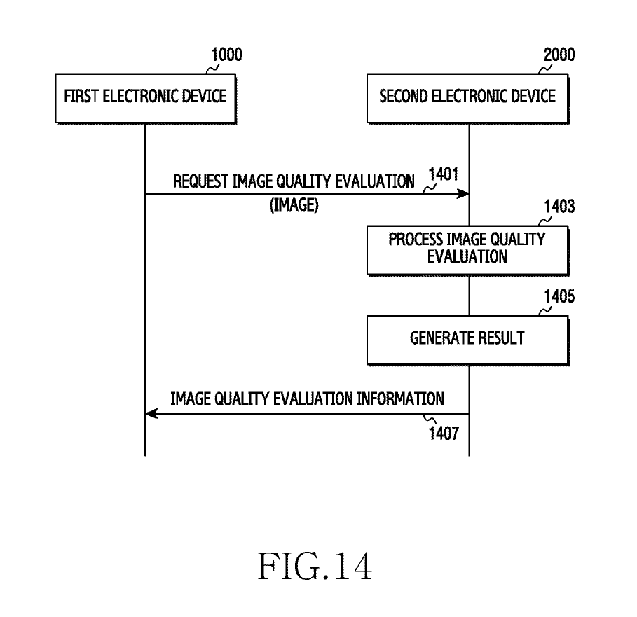

FIG. 14 is a sequence diagram illustrating an example of a method of measuring the quality of an image.

Referring to FIG. 14, FIG. 14 illustrates a sequence diagram illustrating an example in which a second electronic device 2000 (e.g., another electronic device or the server 106) processes an image quality measuring operation according to various example embodiments of the present disclosure. In FIG. 14, a first electronic device 1000 may be an electronic device that requests a measurement of the quality of an image, and the second electronic device 2000 may include a configuration identical or similar to that of the electronic device 400 as described above, and may include a processing module corresponding to the controller 480 of the electronic device 400. The second electronic device 2000 may process at least some (e.g., measurement of the quality of an image and the execution of related functions) of the functions executed by the electronic device 400, and may transmit a result thereof to the first electronic device 1000.

In operation 1401, the first electronic device 1000 transmits an image quality evaluation request to the second electronic device 2000. The first electronic device 1000 may request image quality evaluation with respect to an image stored in the second electronic device 2000, or may request image quality evaluation with respect to an image stored in the first electronic device 1000. When the first electronic device 1000 requests image quality evaluation with respect to an image stored in itself, the first electronic device 1000 may provide the stored image to the second electronic device 2000.

In operation 1403, the second electronic device 2000 processes the image quality evaluation with respect to the image obtained in response to the request of the first electronic device 1000. For example, the second electronic device 200 may execute an operation corresponding to the image quality evaluation processing operation of the electronic device 400, as described above. According to an example embodiment of the present disclosure, the second electronic device 2000 may receive an image from the first electronic device 1000, may analyze a category of the image, and may determine a classifier corresponding to the category of the image. Also, the second electronic device 2000 may determine image quality factor scores of the image. The second electronic device 2000 may execute an image quality evaluation of the image based on the determined image quality factor scores and the determined classifier.

In operation 1405, the second electronic device 2000 may generate a result of processing the image quality evaluation. For example, the second electronic device 2000 may generate image quality evaluation information (e.g., a total image quality score) with respect to the image based on the processing of the image quality evaluation.

In operation 1407, the second electronic device 2000 transmits the image quality evaluation information to the first electronic device 1000.

According to various example embodiments of the present disclosure, the image quality measurement may be executed by the electronic device 400, or by an external device (e.g., the server 106 or another electronic device) that is connected with the electronic device 400.

According to various example embodiments of the present disclosure, a system that supports measuring the quality of an image may include the first electronic device 1000 that requests image quality evaluation of an image; and the second electronic device 2000 that is connected (e.g., in communication with, including wired and/or wireless communication) with the first electronic device 1000, wherein the second electronic device 2000 performs: obtaining the image from the first electronic device; analyzing a category of the image, and determining a classifier corresponding to the category of the image; determining image quality factor scores of the image; and executing an image quality evaluation of the image based on the determined image quality factor scores and the determined classifier, and providing the first electronic device 1000 with a result of the image quality evaluation.

An electronic device, according to various example embodiments of the present disclosure, and an operation method thereof may improve detectability in association with image quality measurement. According to various example embodiments of the present disclosure, the detectability with respect to an out-of-focus background image, the detectability with respect to a motion blur, and the performance with respect to total image quality evaluation may be increased when image quality measurement is executed.

According to various example embodiments of the present disclosure, a good image or a bad image are clearly distinguished in association with an image, and various functions corresponding thereto may be provided. For example, according to various example embodiments of the present disclosure, a bad image may be extracted and readily removed from images stored in an electronic device or an external device (e.g., another electronic device or a server). Management of a memory may be provided by informing a user of an unnecessary image (e.g., a bad image) stored in a memory. Candidate images for image summarization may be proposed based on a good image.

According to various example embodiments of the present disclosure, an electronic device for executing an image quality evaluation may be provided so that user's convenience may be improved, and the usability, convenience, accessibility, and competitiveness of the electronic device may be improved.

The example embodiments of the present disclosure disclosed herein and illustrated in the drawings are merely examples presented in order to easily describe technical details of the present disclosure and to aid in the understanding of the present disclosure, and are not intended to limit the scope of the present disclosure. Therefore, it should be understood that, in addition to the example embodiments disclosed herein, all modifications and changes or modified and changed forms derived from the technical idea of the present disclosure fall within the scope of the present disclosure.

What is claimed is:

1. An electronic device, comprising:
a memory that stores a plurality of images and a plurality of classifiers; and
a processor electrically connected to the memory,
wherein the processor is configured to at least:
analyze a category of an image of which an image quality evaluation is requested, and determine a classifier corresponding to the category of the image from among the plurality of classifiers;
determine image quality factor scores of the image; and
evaluate the image quality of the image based on the determined image quality factor scores and the determined classifier.

2. The electronic device of claim 1, wherein the processor comprises:
an image factor extracting module configured to measure a quality for each image quality factor of the image;
a category classifying module configured to classify an image scene category of the image;
a classifier selecting module configured to select an image quality classifier corresponding to the image scene category; and
an image quality evaluating module configured to determine a total image quality score of the image based on results from the image factor extracting module and the classifier selecting module.

3. The electronic device of claim 2, wherein the category classifying module is configured to analyze the image scene category based on a scheme that classifies an image using feature vectors of the image or a scheme that classifies an image using learning.

4. The electronic device of claim 2, wherein the classifier selecting module is configured to select a classifier corresponding to the image scene category from among image quality classifiers stored in advance in the memory.

5. The electronic device of claim 2, wherein the image factor extracting module is configured to divide the image into a plurality of areas, and to measure a blur factor score for each divided area.

6. The electronic device of claim 5, wherein the image factor extracting module is configured to:
measure a blur factor score for each of the divided areas of the image, and determine, as a target area of measurement, one or more areas that have a high sharpness out of the divided areas,
wherein the target area of measurement includes a predetermined area or a group of a predetermined number of adjacent areas of the divided areas, having a low blur factor score.

7. The electronic device of claim 2, wherein the image factor extracting module is configured to extract, from the image, a distribution of edge components for each direction, and to measure a blur factor score for image quality evaluation based on an area that has a large difference in cumulative edge distributions from among areas where a horizontal edge component and a vertical edge component are perpendicular to each other.

8. The electronic device of claim 2, wherein the image quality evaluating module is configured to extract a likelihood score corresponding to the image, using image quality factor scores that are transferred from the image factor extracting module and the image quality classifier transferred from the classifier selecting module, and to determine a total image quality score with respect to the image based on the extracted likelihood score.

9. The electronic device of claim 2, wherein the processor comprises:
an image managing module configured to obtain the image from the inside or the outside, and to recognize image information for measuring the quality of the image.

10. The electronic device of claim 2, wherein the processor comprises:
a category determining module including processing circuitry, the category determining module configured to determine the image scene category with respect to the image, using the image scene category transferred from the category classifying module and the total image quality score transferred from the image quality evaluating module.

11. A system for measuring a quality of an image, the system comprising:
a first electronic device configured to request image quality evaluation of an image; and
a second electronic device operatively connected to the first electronic device,
wherein the second electronic device is configured to at least:
obtain the image from the first electronic device;
analyze a category of the image, and determine a classifier corresponding to the category of the image;
determine image quality factor scores of the image; and
evaluate an image quality of the image based on the determined image quality factor scores and the determined classifier, and provide the first electronic device with a result of the image quality evaluation.

12. A method of measuring a quality of an image, comprising:
obtaining an image;
classifying an image scene category of the image;
determining a classifier corresponding to the classified image scene category;
determining image quality factor scores with respect to the image; and
evaluating an image quality with respect to the image, using the determined image quality factor scores and the determined classifier.

13. The method of claim 12, wherein the classifying comprises:
analyzing the image scene category based on a scheme that classifies an image using feature vectors of the image and a scheme that classifies an image using learning.

14. The method of claim 12, wherein the determining of the classifier comprises:
selecting a classifier corresponding to the image scene category from among various image quality classifiers stored in advance.

15. The method of claim 12, wherein the determining of the image quality factor scores comprises:
dividing the image into a plurality of areas;
measuring a blur factor score for each of the plurality of divided areas;
determining an area that has a low blur factor score; and
measuring an image quality based on the determined area.

16. The method of claim 15, wherein the determining of an area having a low blur factor score comprises:
determining, as a target area of measurement, one or more areas of the divided areas of the image having a high sharpness,
wherein the target area of measurement includes a predetermined area or a group of a predetermined number of adjacent areas of the divided areas, which has a low blur factor score.

17. The method of claim 12, wherein the determining of the image quality factor scores comprises:
extracting, from the image, a distribution of edge components for each direction;
determining a cumulative edge distribution based on the extracted distribution of edge components for each direction;
determining a target area of decision that includes the largest number of edge components;
determining, from the target area of decision, a target area of measurement based on a difference in cumulative edge distributions; and
measuring an image quality based on the target area of measurement.

18. The method of claim 17, wherein the determining of the target area of measurement comprises:
determining the target area of measurement based on a difference in cumulative edge distributions from among areas where a horizontal edge component and a vertical edge component are perpendicular in the target area of decision.

19. The method of claim 12, wherein the determining of the image quality score comprises:
classifying an image as a high quality image class or a low quality image class using the image quality factor scores and the classifier;
extracting a likelihood score corresponding to the image; and
determining a total image quality score with respect to the image, based on the extracted likelihood score.

20. A computer readable recording medium that stores a program which, when executed in an electronic device, causes the electronic device to perform operations comprising:
classifying an image scene category of an image and determining a classifier corresponding to the classified image scene category;
determining image quality factor scores with respect to the image; and
evaluating an image quality with respect to the image, using the determined image quality factor scores and the determined classifier.
